(19) United States
(12) Patent Application Publication
(10) Pub. No.: US 2026/0148464 A1
(43) Pub. Date: May 28, 2026

(54) ANIMATION PROCESSING METHOD AND APPARATUS, ELECTRONIC DEVICE, COMPUTER-READABLE STORAGE MEDIUM, AND COMPUTER PROGRAM PRODUCT

(71) Applicant: TENCENT TECHNOLOGY (SHENZHEN) COMPANY LIMITED, Shenzhen (CN)

(72) Inventors: Ruoyun ZHANG, Shenzhen (CN); Wenhan ZHANG, Shenzhen (CN); Yinxiang SUN, Shenzhen (CN); Jianfeng LIN, Shenzhen (CN)

(21) Appl. No.: 19/455,220

(22) Filed: Jan. 21, 2026

Related U.S. Application Data
(63) Continuation of application No. PCT/CN2024/118016, filed on Sep. 10, 2024.

(30) Foreign Application Priority Data
Nov. 30, 2023 (CN) 202311638505.6

(51) Int. Cl. G06T 13/40

(52) U.S. Cl. CPC G06T 13/40

(57) ABSTRACT

An animation processing method includes obtaining first and second animation files of first and second virtual objects, respectively, extracting first and second object skeletons of the first and second virtual objects from the first and second animation files, respectively, adding a bone socket to a first bone of the first object skeleton, mounting a second bone of the second object skeleton onto the bone socket, and controlling the second bone to move along with the first bone based on the bone socket in response to playing of a mounting animation that presents the second virtual object being mounted on the first virtual object. During movement of the second bone along with the first bone, an object part, bound to the second bone, of the second virtual object moves along with an object part, bound to the first bone, of the first virtual object.

### CROSS-REFERENCE TO RELATED APPLICATIONS

This application is a continuation of International Application No. PCT/CN2024/118016, filed on Sep. 10, 2024, which is based on and claims priority to Chinese Patent Application No. 2023116385056, filed on Nov. 30, 2023, the entire contents of both of which are incorporated herein by reference.

### FIELD OF THE TECHNOLOGY

This application relates to the field of computer technologies, and in particular, to an animation processing method and apparatus, an electronic device, a computer-readable storage medium, and a computer program product.

### BACKGROUND OF THE DISCLOSURE

In screens of film and television animations, virtual scenes (for example, games), and the like, there is often an animation effect that one virtual object (that is, a mounted object) is mounted on another virtual object (that is, a carrier object), to achieve synchronous movement of two objects. For example, one virtual object rides on another virtual object. In the related art, (1) a plurality of different animation assets and animation logics are respectively created for a carrier object and a mounted object, which, although allowing for implementing a plurality of different mounting poses, leads to extremely high production cost; or (2) only one set of animation asset and animation logic is created for a carrier object and a mounted object, but this results in a highly unified mounting pose and leads to a poor animation effect.

### SUMMARY

In accordance with the disclosure, there is provided an animation processing method performed by an electronic device and including obtaining a first animation file of a first virtual object and a second animation file of a second virtual object, extracting a first object skeleton of the first virtual object from the first animation file, extracting a second object skeleton of the second virtual object from the second animation file, adding a bone socket to a first bone of the first object skeleton, mounting a second bone of the second object skeleton onto the bone socket, and controlling the second bone to move along with the first bone based on the bone socket in response to playing of a mounting animation that presents the second virtual object being mounted on the first virtual object. During movement of the second bone along with the first bone, an object part, bound to the second bone, of the second virtual object moves along with an object part, bound to the first bone, of the first virtual object.

Also in accordance with the disclosure, there is provided an electronic device including a memory storing computer-executable instructions, and a processor configured to execute the computer-executable instructions to obtain a first animation file of a first virtual object and a second animation file of a second virtual object, extract a first object skeleton of the first virtual object from the first animation file, extract a second object skeleton of the second virtual object from the second animation file, add a bone socket to a first bone of the first object skeleton, mount a second bone of the second object skeleton onto the bone socket, and control the second bone to move along with the first bone based on the bone socket in response to playing of a mounting animation that presents the second virtual object being mounted on the first virtual object. During movement of the second bone along with the first bone, an object part, bound to the second bone, of the second virtual object moves along with an object part, bound to the first bone, of the first virtual object.

Also in accordance with the disclosure, there is provided a non-transitory computer-readable storage medium storing computer-executable instructions or a computer program that, when executed by a processor, causes an electronic device including the processor to obtain a first animation file of a first virtual object and a second animation file of a second virtual object, extract a first object skeleton of the first virtual object from the first animation file, extract a second object skeleton of the second virtual object from the second animation file, add a bone socket to a first bone of the first object skeleton, mount a second bone of the second object skeleton onto the bone socket, and control the second bone to move along with the first bone based on the bone socket in response to playing of a mounting animation that presents the second virtual object being mounted on the first virtual object. During movement of the second bone along with the first bone, an object part, bound to the second bone, of the second virtual object moves along with an object part, bound to the first bone, of the first virtual object.

### BRIEF DESCRIPTION OF THE DRAWINGS

FIG. 1 is a schematic diagram showing an architecture of an animation processing system according to an embodiment of this application.

FIG. 2 is a schematic structural diagram of an electronic device according to an embodiment of this application.

FIG. 3 is a first schematic flowchart of an animation processing method according to an embodiment of this application.

FIG. 4A is a first schematic display diagram showing a mounting animation according to an embodiment of this application.

FIG. 4B is a second schematic display diagram showing a mounting animation according to an embodiment of this application.

FIG. 4C is a third schematic display diagram showing a mounting animation according to an embodiment of this application.

FIG. 5 is a second schematic flowchart of an animation processing method according to an embodiment of this application.

FIG. 6 is a schematic diagram showing a second object skeleton of a second virtual object according to an embodiment of this application.

FIG. 7A is a first schematic creation flowchart of a mounting animation blueprint according to an embodiment of this application.

FIG. 7B is a second schematic creation flowchart of a mounting animation blueprint according to an embodiment of this application.

FIG. 8A is a first schematic creation flowchart of a second animation blueprint according to an embodiment of this application.

FIG. 8B is a second schematic creation flowchart of a second animation blueprint according to an embodiment of this application.

FIG. 8C is a third schematic creation flowchart of a second animation blueprint according to an embodiment of this application.

FIG. 8D is a fourth schematic creation flowchart of a second animation blueprint according to an embodiment of this application.

FIG. 8E is a fifth schematic creation flowchart of a second animation blueprint according to an embodiment of this application.

FIG. 8F is a sixth schematic creation flowchart of a second animation blueprint according to an embodiment of this application.

FIG. 8G is a seventh schematic creation flowchart of a second animation blueprint according to an embodiment of this application.

FIG. 9A is a first schematic logic editing flowchart of a second animation blueprint according to an embodiment of this application.

FIG. 9B is a second schematic logic editing flowchart of a second animation blueprint according to an embodiment of this application.

FIG. 9C is a third schematic logic editing flowchart of a second animation blueprint according to an embodiment of this application.

FIG. 9D is a fourth schematic logic editing flowchart of a second animation blueprint according to an embodiment of this application.

FIG. 9E is a fifth schematic logic editing flowchart of a second animation blueprint according to an embodiment of this application.

FIG. 10A is a first schematic creation flowchart of a first animation blueprint according to an embodiment of this application.

FIG. 10B is a second schematic creation flowchart of a first animation blueprint according to an embodiment of this application.

FIG. 10C is a third schematic creation flowchart of a first animation blueprint according to an embodiment of this application.

FIG. 10D is a fourth schematic creation flowchart of a first animation blueprint according to an embodiment of this application.

FIG. 11A is a first schematic creation flowchart of a mounting animation blueprint according to an embodiment of this application.

FIG. 11B is a second schematic creation flowchart of a mounting animation blueprint according to an embodiment of this application.

FIG. 11C is a third schematic creation flowchart of a mounting animation blueprint according to an embodiment of this application.

The foregoing “first” and “second” are only used to distinguish between different solutions, and are not intended to represent the distinction between the advantages and disadvantages of the solutions or the priority in the implementation process.

### DESCRIPTION OF EMBODIMENTS

To make objectives, technical solutions, and advantages of this application clearer, the following further describes this application in detail with reference to the accompanying drawings. The described embodiments are not intended to be construed as limiting this application. All other embodiments obtained by a person of ordinary skill in the art without creative efforts still fall within the scope of protection of this application.

“Some embodiments” involved in the following description describes a subset of all possible embodiments. However, “some embodiments” may be the same subset or different subsets of all possible embodiments, and may be combined with each other without conflict.

The terms “first/second/third” involved in the following description are merely intended to distinguish between similar objects and do not indicate a specific sequence of the objects. “First/second/third” may, where permissible, be interchanged in specific order or sequence to enable the embodiments of this application described herein to be implemented in sequences other than those illustrated or described herein.

In embodiments of this application, the term “module” or “unit” refers to a computer program having a predetermined function or a part of a computer program, operates together with other relevant parts to achieve a predetermined objective, and may be all or partially implemented by using software, hardware (such as a processing circuit or a memory), or a combination thereof. Similarly, one processor (or a plurality of processors or memories) may be configured to implement one or more modules or units. In addition, each module or unit may be a part of an overall module or unit including a function of the module or unit.

Unless otherwise defined, all technical and scientific terms used in the embodiments of this application have the same meanings as those commonly understood by a person skilled in the art. Terms used in the embodiments of this application are merely intended to describe objectives of the embodiments of this application, but are not intended to limit this application.

Before the embodiments of this application are further described in detail, the nouns and terms involved in the embodiments of this application are explained. The nouns and terms involved in the embodiments of this application are subject to the following interpretations.
(1) Client: an application run in a terminal for providing various services, such as a client supporting animation processing.
(2) “In response to”: configured for representing a condition or a status on which implementation of an operation depends, and when the dependent condition or status is satisfied, one or more operations may be implemented in real time or with a set delay. Unless otherwise specified, the implementation order of the plurality of operations is not limited.
3) Riding: refers to a mounted object achieving an objective of enhancing a mobility of the mounted object by riding a carrier object such as a vehicle or an animal.
4) Digital Content Creation (DCC) software: a general name of a type of software for creating animation characters, including 3D Studio Max, Maya, Blender, Houdini, and the like. 3D Studio Max (3d Max or 3ds MAX for short) is three-dimensional animation rendering and production software based on a computer system.
5) Skeleton: includes bones and joints. Bones represent a coordinate space, and a bone hierarchy is a nested coordinate space. A joint describes a location of a bone (that is, the origin of a bone in a bone coordinate space) in a parent space of the joint. Rotation about the joint refers to rotation of the bone coordinate space (including all child spaces).
6) Skeletal animation: each animated character at least includes two primary types of data: a skeleton and a model. In a game/film and television animation production process, a process of driving a model (changing an appearance of a character model) by poses of a skeleton is referred to as skeletal animation.
7) Skinning: refers to attaching (binding) a vertex of a model (Mesh) to a bone, where each vertex may be controlled by a plurality of bones. In this way, because a vertex at a joint is pulled by a parent bone and a child bone, a location of the vertex is changed, to eliminate a crack.
8) Blueprint: a special type of resource in an Unreal Engine (UE), and provides an intuitive node-based interface for creating a new type of Actor and a level script event. It provides a level designer and a game developer with a tool to quickly create and iterate game playability in an Unreal Editor without writing a single line of code.
9) Animation blueprint: configured for performing animation blending, directly controlling bones of a skeleton, or setting up logic for a final animated pose that will ultimately define a skeletal mesh to be used for each frame of animation.
10) Socket (namely, bone socket): an appellation in UE, has an effect similar to that of a bone, and may be added to a skeletal mesh and used as a locator of an attachment point of a virtual prop, an effect, and the like.
11) Control Rig: an animation tool provided by UE, and may be used by a user to directly rig and produce an animation on an animated character in UE, which is referred to as a “controlling rig.” By using Control Rig, a need of rigging and producing an animation in an external tool may be avoided, and animation production is directly performed in UE.
12) Full Body Inverse Kinematics (FBIK): an apparatus with a high degree of controllability and flexibility can be constructed in Control Rig by using an FBIK function of Control Rig. A holistic solver method is built on a location-based IK framework, and the framework can achieve fast rig performance, per-bone settings, a preferred angle, pressing, stretching, and the like. FBIK is designated to function as a procedural adjustment tool in Control Rig, which enables, for example, ground alignment or arm stretching behavior.

Based on the foregoing explanations of the nouns and terms involved in the embodiments of this application, the following describes the embodiments of this application in detail. The embodiments of this application provide an animation processing method and apparatus, an electronic device, a computer-readable storage medium, and a computer program product, to enhance an animation effect and reduce animation production cost.

During application of the embodiments, collection and processing of relevant data in this application needs to strictly adhere to the requirements of relevant laws and regulations, to obtain the informed consent or separate consent from personal information subjects, and subsequent data usage and processing activities are performed within the scope authorized by the laws and regulations and the personal information subjects.

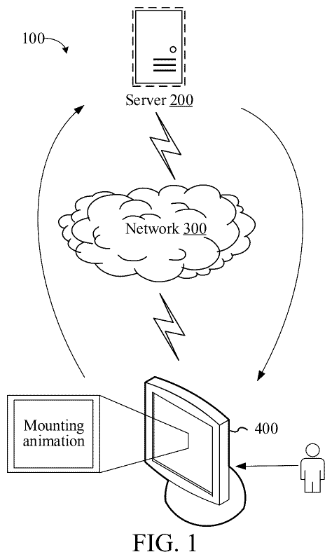

The following describes an animation processing system provided in the embodiments of this application. FIG. 1 is a schematic diagram showing an architecture of an animation processing system according to an embodiment of this application. To support an exemplary application, an animation processing system 100 includes: a server 200, a network 300, and a terminal 400. The terminal 400 is connected to the server 200 via the network 300. The network 300 may be a wide area network, a local area network, or a combination of the two. Data transmission is implemented via a wireless or wired link.

Herein, the terminal 400 (for example, running a client supporting animation processing) transmits an animation obtaining request to the server 200 in response to an animation processing instruction, the animation obtaining request instructing to obtain a first animation file of a first virtual object and a second animation file of a second virtual object. The server 200 receives the animation obtaining request transmitted by the terminal 400; and returns the first animation file of the first virtual object and the second animation file of the second virtual object to the terminal 400 in response to the animation obtaining request. The terminal 400 receives the first animation file of the first virtual object and the second animation file of the second virtual object that are returned by the server 200; extracts a first object skeleton of the first virtual object from the first animation file, and extracts a second object skeleton of the second virtual object from the second animation file; adds a bone socket to a first bone of the first object skeleton; mounts a second bone of the second object skeleton onto the bone socket; and controls the second bone to move along with the first bone based on the bone socket when a mounting animation is played and the mounting animation is configured for presenting that the second virtual object is mounted on the first virtual object, during movement of the second bone along with the first bone, an object part, bound to the second bone, of the second virtual object moving along with an object part, bound to the first bone, of the first virtual object. In this way, an animation effect of mounting the second virtual object on the first virtual object to achieve synchronous movement can be enhanced, to make the animation effect of mounting the second virtual object on the first virtual object to achieve synchronous movement more realistic.

In some embodiments, the animation processing method provided in the embodiments of this application is implemented by an electronic device, for example, may be implemented by a terminal alone, or may be implemented by a server alone, or may be implemented by the terminal and the server collaboratively. The embodiments of this application are applicable to various scenarios, including but not limited to a cloud technology, artificial intelligence, intelligent transportation, assisted driving, videos, instant messaging, games, metaverse, and the like.

In some embodiments, the electronic device for implementing the animation processing method provided in the embodiments of this application may be any type of terminal or server. The server (such as the server 200) may be an independent physical server, or may be a server cluster or distributed system including a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), and a big data and artificial intelligence platform. The terminal (such as the terminal 400) may be, but is limited to, a laptop computer, a tablet computer, a desktop computer, a smartphone, an intelligent voice interaction device (such as a smart speaker), a smart home appliance (such as a smart television), a smart watch, an on-board terminal, a wearable device, a virtual reality (VR) device, an aircraft, or the like. The terminal and the server may be connected directly or indirectly by using a wired or wireless communication protocol. This is not limited in embodiments of this application.

In some embodiments, the terminal or the server may implement the animation processing method provided in the embodiments of this application by running various computer-executable instructions or a computer program. For example, the computer-executable instructions may be a microprogram-level command, machine instructions, or software instructions. The computer program may be a native program or a software module in an operating system; may be a native application (APP), namely, a program that needs to be installed in an operating system to run; or may be a mini program that may be embedded in any APP, namely, a program that only needs to be downloaded into a browser environment to run. To sum up, the foregoing computer-executable instructions may be instructions in any form, and the foregoing computer program may be an application, a module, or a plug-in in any form.

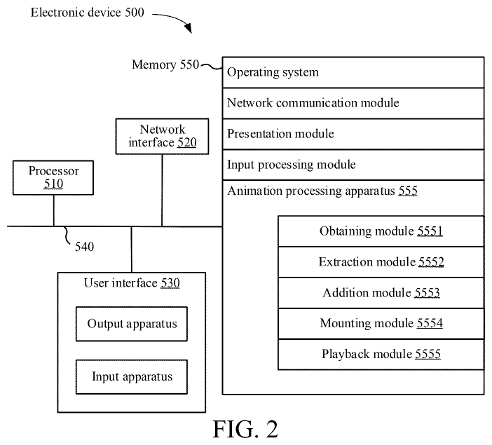

The following describes an electronic device that implements an animation processing method provided in the embodiments of this application. FIG. 2 is a schematic structural diagram of an electronic device according to an embodiment of this application. An electronic device 500 provided in the embodiments of this application may be a terminal or may be a server. As shown in FIG. 2, the electronic device 500 includes: at least one processor 510, a memory 550, at least one network interface 520, and a user interface 530. Components in the electronic device 500 are coupled together via a bus system 540. The bus system 540 is configured to implement connection and communication between the components. In addition to a data bus, the bus system 540 further includes a power bus, a control bus, and a state signal bus. However, for ease of clear description, all types of buses are marked as the bus system 540 in FIG. 2.

In some embodiments, an animation processing apparatus provided in the embodiments of this application may be implemented in a form of software. FIG. 2 shows an animation processing apparatus 555 stored in the memory 550. The animation processing apparatus may be software in a form of a program, a plug-in, or the like, and includes the following software modules: an obtaining module 5551, an extraction module 5552, an addition module 5553, a mounting module 5554, and a playback module 5555. Because these modules are logical, they may be combined in different ways or further split according to an implemented function. Functions of the modules are described below.

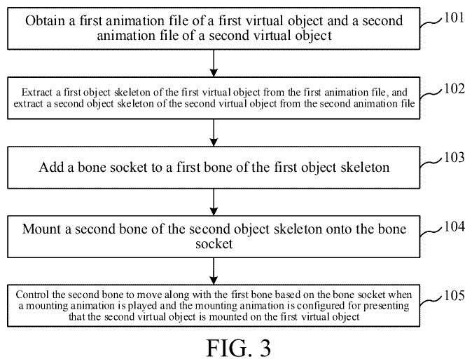

The following describes an animation processing method provided in the embodiments of this application. As described above, the animation processing method provided in the embodiments of this application is implemented by an electronic device, for example, may be implemented by a terminal or a server alone, or may be implemented by the terminal and the server collaboratively. Therefore, an executive subject of each operation is not repeatedly described below. FIG. 3 is a schematic flowchart of an animation processing method according to an embodiment of this application. The animation processing method provided in the embodiments of this application includes:
Operation 101: Obtain a first animation file of a first virtual object and a second animation file of a second virtual object.

In operation 101, a user can trigger an animation processing instruction on an electronic device. In this case, the electronic device obtains the first animation file of the first virtual object and the second animation file of the second virtual object in response to the animation processing instruction. The first animation file and the second animation file may be pre-created manually (for example, created in an application supporting animation file creation), or may be automatically generated based on artificial intelligence. When the first animation file and the second animation file need to be used, the first animation file and the second animation file may be imported into a client supporting animation processing. The first virtual object and the second virtual object may be virtual objects (such as a virtual person or a virtual animal) automatically generated based on artificial intelligence, or may be virtual objects designed and created by the user. The first virtual object and the second virtual object may be virtual objects in an animated video (such as a film and television animation or an animation), or may be virtual objects in a virtual scene (such as a game scene). The first virtual object and the second virtual object may be the same or may be different.

In some embodiments, the first animation file of the first virtual object and the second animation file of the second virtual object may be obtained by performing the following operations: a first standby animation file and a motion animation file of the first virtual object are obtained, and the first standby animation file and the motion animation file are taken as the first animation file; a second standby animation file of the second virtual object is obtained, and the second standby animation file is taken as the second animation file, the second virtual object in the second standby animation file being in a target pose, and the target pose being a pose adopted when the second virtual object is mounted on the first virtual object.

Herein, the first animation file of the first virtual object includes the first standby animation file and the motion animation file of the first virtual object. The first standby animation file is a pre-created animation file of the first virtual object in a particular pose (for example, standing in situ), and the first standby animation file includes at least one animation frame (the at least one animation frame forming one first standby animation sequence). The motion animation file is a pre-created animation file that presents a motion process (such as running, flying, jumping, and crawling) of the first virtual object, and the motion animation file includes a plurality of animation frames (the plurality of animation frames forming one motion animation sequence). The second animation file of the second virtual object is the second standby animation file of the second virtual object. The second standby animation file is a pre-created animation file of the second virtual object in the target pose, and the second standby animation file includes at least one animation frame (the at least one animation frame forming one second standby animation sequence). The target pose may be the pose adopted when the second virtual object is mounted on the first virtual object, such as a pose in which the second virtual object rides on the first virtual object, or a pose in which the second virtual object lies prone on the first virtual object. The second virtual object is mounted on the first virtual object in the target pose. In this way, based on the pre-created first standby animation file and motion animation file of the first virtual object and the pre-created second standby animation file of the second virtual object, a subsequent mounting animation supporting a plurality of different mounting poses can be implemented, without the need of respectively creating different animation assets and animation logic for the first virtual object and the second virtual object for different mounting poses. Therefore, implementation cost of the mounting animation is reduced, and the production efficiency of the mounting animation is enhanced.

The mounting animation is configured for presenting a process of mounting the second virtual object onto the first virtual object to achieve synchronous movement. To be specific, in the mounting animation, the second virtual object can be mounted on the first virtual object in the target pose, and the second virtual object move along with the first virtual object during movement of the first virtual object. Based on the added bone socket in the embodiments of this application, the second bones of the second virtual object can move along with the first bone of the first virtual object, to enable the object part, bound to the second bone, of the second virtual object to move along with the object part, bound to the first bone, of the first virtual object. In this way, an animation effect of mounting the second virtual object onto the first virtual object to achieve synchronous movement can be enhanced, to make the animation effect of mounting the second virtual object onto the first virtual object to achieve synchronous movement more realistic.
Operation 102: Extract a first object skeleton of the first virtual object from the first animation file, and extract a second object skeleton of the second virtual object from the second animation file.

In operation 102, after the first animation file and the second animation file are obtained, the first animation file and the second animation file are parsed, the first object skeleton of the first virtual object is extracted from the first animation file, and the second object skeleton of the second virtual object is extracted from the second animation file. Herein, the first object skeleton includes a plurality of bones and a bone joint between any two bones, and the second object skeleton also includes a plurality of bones and a bone joint between any two bones.

In some embodiments, in addition to the first object skeleton, the first animation file further includes an animation sequence of the first virtual object (specifically including the foregoing first standby animation sequence and motion animation sequence), and a skeletal mesh (which may also be understood as a three-dimensional object model of the first virtual object). Similarly, in addition to the second object skeleton, the second animation file further includes an animation sequence of the second virtual object (specifically, the foregoing second standby animation sequence), and a skeletal mesh (which may also be understood as a three-dimensional object model of the second virtual object).
Operation 103: Add a bone socket to a first bone of the first object skeleton.

In operation 103, for the extracted first object skeleton of the first virtual object, the first bone to be added with the bone socket is determined from the first object skeleton. Herein, the first bone may be any bone in the first object skeleton that is preset based on an animation requirement (such as a requirement of a mounting pose) of a mounting animation, for example, may be a pelvic bone or a shoulder bone of the first object skeleton. After the first bone to be added with the bone socket is determined, the bone socket is added to the first bone. The bone socket is configured for mounting a second bone of the second object skeleton of the second virtual object. The second bone may be any bone in the second object skeleton that is preset based on an animation requirement (such as a requirement of a mounting pose) of a mounting animation, for example, may be a thigh bone, a shoulder bone, or a limb bone of the second object skeleton. There may be one or more first bones. Similarly, there may be one or more second bones. The bone socket is configured for setting a mounting location of the second virtual object relative to the first virtual object and configured for constraining the second bone of the second virtual object. There may be one or more bone sockets. One or more bone sockets may be added to each first bone. Each bone socket may be configured for mounting one or more second bones. The bone socket may include a first bone socket indicating a direct mounting location of the second virtual object relative to the first virtual object and a second bone socket indicating an indirect mounting location of the second virtual object relative to the first virtual object.

In some embodiments, the bone socket may be added to the first bone of the first object skeleton by performing the following operations: a first bone socket is added to a first sub-bone of the first object skeleton, the first bone socket indicating a direct mounting location of the second virtual object relative to the first virtual object; a second bone socket is added to a second sub-bone of the first object skeleton, the second bone socket indicating an indirect mounting location of the second virtual object relative to the first virtual object, and the second bone socket being configured for constraining movement of a target bone in the second bone; and the first bone including the first sub-bone and the second sub-bone, and the bone socket including the first bone socket and the second bone socket.

Herein, first, the first bone socket is added to the first sub-bone of the first object skeleton. The first bone socket actually indicates the direct mounting location of the second virtual object relative to the first virtual object. That is, the second virtual object is mounted on the first virtual object through the first bone socket, and the first bone socket is a direct contact location between the second virtual object and the first virtual object. If the first sub-bone corresponding to the first bone socket is different, the second virtual object is mounted on the first virtual object at a different location. Next, the second bone socket is added to the second sub-bone of the first object skeleton. The second bone socket actually indicates the indirect mounting location of the second virtual object relative to the first virtual object. That is, the second virtual object does not directly contact the first virtual object at the location of the second bone socket. However, the second sub-bone of the first virtual object can constrain motion of the target bone in the second virtual object through the second bone socket, that is, the target bone of the second virtual object moves along with the second sub-bone of the first virtual object.

In this way, the second virtual object can be mounted on the first virtual object through the first bone socket, to enable the bone of the second virtual object directly mounted on the first bone socket to move along with the first sub-bone. The bone of the second virtual object that is not in direct contact with the first virtual object can also move along with the bone of the first virtual object through the second bone socket. In this way, the first virtual object and the second virtual object can interact with each other at both the direct contact location and the non-direct contact location (for example, a direct contact location “pelvic bone location,” and a non-direct contact location “the limbs and the head”), to achieve a realistic animation effect of a mounting animation. In addition, the diversity of mounting poses is further increased, the second virtual object can be mounted on the first virtual object in a variety of mounting poses, and the animation effect of the mounting animation is enhanced.
Operation 104: Mount a second bone of the second object skeleton onto the bone socket.

In operation 104, after the bone socket is added to the first bone of the first object skeleton, the second bone of the second object skeleton can be mounted onto the bone socket, to mount the second virtual object onto the first virtual object. The second bone may be any bone in the second object skeleton that is preset based on an animation requirement (such as a requirement of a mounting pose) of a mounting animation, for example, may be a head bone, a hip bone, or a limb bone of the second object skeleton. A mounting animation of mounting the second virtual object onto the first virtual object is configured for presenting that: the second virtual object is mounted on the first virtual object, and the second virtual object moves along with the first virtual object during movement of the first virtual object. The second bone of the second virtual object is controlled to move along with the first bone of the first virtual object through the bone socket, to enable an object part, bound to the second bone, of the second virtual object to move along with an object part, bound to the first bone, of the first virtual object.

In some embodiments, before the second bone of the second object skeleton is mounted onto the bone socket, the following operations are further performed: a mounting animation blueprint of the mounting animation is created, a first animation blueprint of the first virtual object is created, and a second animation blueprint of the second virtual object is created; a first skeletal mesh and a second skeletal mesh are added to the mounting animation blueprint, the first skeletal mesh and the second skeletal mesh having a hierarchical relationship, and the first skeletal mesh being a parent of the second skeletal mesh; a first object model of the first virtual object is obtained, and the first object model and the first animation blueprint are placed in the first skeletal mesh, to obtain a third skeletal mesh including the first object skeleton; and a second object model of the second virtual object is obtained, and the second object model and the second animation blueprint are placed in the second skeletal mesh, to obtain a fourth skeletal mesh including the second object skeleton.

Herein, first, the mounting animation blueprint of the mounting animation, the first animation blueprint of the first virtual object, and the second animation blueprint of the second virtual object are created. Exemplarily, the mounting animation blueprint, the first animation blueprint, and the second animation blueprint may be created in an application supporting animation production. The mounting animation blueprint is configured for playing the mounting animation, the first animation blueprint is configured for playing an animation of the first virtual object, and the second animation blueprint is configured for playing an animation of the second virtual object. The second virtual object is constrained by the bone socket of the first virtual object, to enable the second virtual object to interact with the first virtual object.

Second, the first skeletal mesh corresponding to the first virtual object and the second skeletal mesh of the second virtual object are added to the mounting animation blueprint. The first skeletal mesh is configured for displaying the first virtual object, and the second skeletal mesh is configured for displaying the second virtual object. The first skeletal mesh and the second skeletal mesh have the hierarchical relationship, the first skeletal mesh is the parent of the second skeletal mesh, and the second skeletal mesh is a child of the first skeletal mesh. In this way, it can be ensured that the second virtual object in the second skeletal mesh is mounted on the first virtual object in the first skeletal mesh, and the second virtual object in the second skeletal mesh is constrained by the bone socket of the first virtual object in the first skeletal mesh, to achieve a mounting animation.

Third, the first object model of the first virtual object is obtained, and the second object model of the second virtual object is obtained. The first object model may be a three-dimensional object model of the first virtual object and is obtained by performing skinning processing on the first object skeleton. The second object model may be a three-dimensional object model of the second virtual object and is obtained by performing skinning processing on the second object skeleton. Fourth, the first object model and the first animation blueprint are placed in the first skeletal mesh, to achieve an objective of displaying the first virtual object in the mounting animation blueprint, and to obtain the third skeletal mesh. That is, the third skeletal mesh is configured for displaying the first virtual object in the mounting animation blueprint. The second object model and the second animation blueprint are placed in the second skeletal mesh, to achieve an objective of displaying the second virtual object in the mounting animation blueprint, and to obtain the fourth skeletal mesh. That is, the fourth skeletal mesh is configured for displaying the second virtual object in the mounting animation blueprint. In this way, it can be ensured that the second virtual object is mounted on the first virtual object, and the second virtual object is constrained by the bone socket of the first virtual object, to achieve a mounting animation. In addition, addition and display of the first virtual object and the second virtual object in the mounting animation blueprint are achieved, whereby playback of the mounting animation is achieved.

In some embodiments, the third skeletal mesh includes the first object skeleton, and the fourth skeletal mesh includes the second object skeleton. In this way, the second bone of the second object skeleton may be mounted onto the bone socket by performing the following operations: a blueprint node is created in the mounting animation blueprint, the blueprint node including a socket pin, a first pin indicating a mounting object, and a second pin indicating a mounted object; and the third skeletal mesh is controlled to be connected to the first pin, the fourth skeletal mesh is controlled to be connected to the second pin, and the socket pin is controlled to indicate the bone socket. Based on this, the second bone of the second object skeleton is mounted onto the bone socket.

Herein, because the first object model is obtained by performing skinning processing on the first object skeleton, the third skeletal mesh includes the first object skeleton. Similarly, because the second object model is obtained by performing skinning processing on the second object skeleton, the fourth skeletal mesh includes the second object skeleton. Based on this, after the third skeletal mesh and the fourth skeletal mesh are obtained, the blueprint node may be created in the mounting animation blueprint. Herein, the created blueprint node includes the socket pin, the first pin indicating a mounting object (that is, a carrier), and the second pin indicating a mounted object. In this way, the third skeletal mesh (corresponding to the first virtual object) can be controlled to be connected to the first pin, the fourth skeletal mesh (corresponding to the second virtual object) can be controlled to be connected to the second pin, and the socket pin is controlled to indicate the bone socket (for example, the socket pin is associated with a socket name of the bone socket), to mount the second bone of the second object skeleton onto the bone socket. In this way, mounting of the second bone onto the bone socket is achieved in the mounting animation blueprint, to achieve the mounting animation in the mounting animation blueprint.

In some embodiments, an animation running control node may further be created in the mounting animation blueprint, and then the animation running control node is controlled to be connected to the blueprint node. In this way, it can be ensured that when the animation running control node controls running of the mounting animation blueprint, the second virtual object is mounted onto the bone socket of the first virtual object, and the second bone is controlled to move along with the first bone based on the bone socket, to enable the object part, bound to the second bone, of the second virtual object to move along with the object part, bound to the first bone, of the first virtual object. In this way, the animation running control node can control playback of the mounting animation, which facilitates operation and enhances the interaction efficiency.

In some embodiments, the first virtual object may have a plurality of motion poses, such as walking on land, running, swimming, floating, flying, and surfing. Therefore, for different motion poses of the first virtual object, the second virtual object may be mounted on the first virtual object in different mounting poses. Specifically, first, a motion pose of the first virtual object may be obtained; then, a mounting pose, adapted to the motion pose, of the second virtual object is determined; and the first bone to be added with the bone socket in the first object skeleton and the second bone to be mounted onto the bone socket in the second object skeleton are determined based on the motion pose and the mounting pose.

Herein, for different motions poses, mounting poses matching the motion poses may be configured, that is, a matching relationship between the motion poses and the mounting poses is configured, and different motion poses match different mounting poses. After the motion pose of the first virtual object is obtained, the mounting pose matching the motion pose may be determined based on the configured matching relationship. The mounting pose is the mounting pose of the second virtual object. For different motion poses of the first virtual object and different mounting poses of the second virtual object, different first bones and different second bones may be determined. Therefore, when the second virtual object is mounted on the first virtual object, the mounting pose and the bone constraint manner based on the bone socket may also be different. Based on this, by adding the bone socket to the first bone determined based on the motion pose and the mounting pose matching the motion pose, and mounting the second bone determined based on the motion pose and the mounting pose matching the motion pose onto the bone socket, the second virtual object can be mounted on the first virtual object in the mounting pose adapted to the motion pose. In this way, the diversity of mounting poses for the mounting animation can be increased, to make the mounting pose more adaptive to the motion pose of the first virtual object, and to make the animation effect more realistic.

Exemplarily, in a virtual scene (such as a game scene), if the second virtual object is mounted on the first virtual object in different mounting poses for different motion poses of the first virtual object, during switching of motion poses of the first virtual object in the virtual scene, the mounting poses of the second virtual object are also correspondingly switched with the change in the motion pose of the first virtual object. For example, if the motion pose of the first virtual object is switched from a first motion pose (such as running) to a second motion pose (such as swimming), the mounting pose in which the second virtual object is mounted on the first virtual object may be switched from a first mounting pose (such as riding) to a second mounting pose (such as laying prone). The first mounting pose is adapted to the first motion pose, and the first bone added with the bone socket and the second bone mounted onto the bone socket are both determined based on the first motion pose. The second mounting pose is adapted to the second motion pose, and the first bone added with the bone socket and the second bone mounted onto the bone socket are both determined based on the second motion pose. In this way, an animation effect in the virtual scene and an experience in the virtual scene can be enhanced.
Operation 105: Control the second bone to move along with the first bone based on the bone socket when a mounting animation is played and the mounting animation is configured for presenting that the second virtual object is mounted on the first virtual object.

During movement of the second bone along with the first bone, an object part, bound to the second bone, of the second virtual object moves along with an object part, bound to the first bone, of the first virtual object.

In operation 105, when the mounting animation configured for presenting that the second virtual object is mounted on the first virtual object is played, the second bone of the second virtual object can be controlled to move along with the first bone of the first virtual object based on the bone socket, to enable the object part, bound to the second bone, of the second virtual object to move along with the object part, bound to the first bone, of the first virtual object. The object part is obtained by binding a model vertex of a bone corresponding to the object part to the bone of the object part for skinning. Specifically, when the first bone includes a first sub-bone and a second sub-bone, a first bone socket is added to the first sub-bone, and a second bone socket is added to the second sub-bone, the second virtual object can be controlled to be mounted on the first virtual object through the first bone socket, to enable a bone of the second virtual object directly mounted on the first bone socket to move along with the first sub-bone. A bone of the second virtual object not in direct contact with the first virtual object can be controlled to move along with the bone of the first virtual object through the second bone socket. In this way, the first virtual object and the second virtual object can interact with each other at both a direct contact location and a non-direct contact location (such as a direct contact location “pelvic bone location” and a non-direct contact location “the limbs and the head”), to make an animation effect of a mounting animation more realistic, whereby the animation effect of the mounting animation is enhanced.

In this way, the bone socket is added to the first bone of the first object skeleton, and the second bone of the second object skeleton is mounted onto the bone socket. The first bone may be any bone of the first object skeleton, and the second bone may be any bone of the second object skeleton. Therefore, mounting in different poses can be achieved through the bone socket only by adjusting an addition location or mounting location of the bone socket (that is, which first bone of the first object skeleton is added with the bone socket and which second bone of the second object skeleton is mounted onto the bone socket), without the need of creating animation assets and animation logic for different mounting poses, whereby animation production cost is reduced.

In some embodiments, when a mounting animation is played through an application supporting animation production, a playback instruction for the mounting animation may be triggered by triggering a running instruction for a mounting animation blueprint. In some embodiments, the mounting animation may be a partial animation in a to-be-played animation (such as a film and television animation or an animation). In some embodiments, the mounting animation may be a partial animation in a virtual scene (such as a game scene).

In some embodiments, the first animation blueprint of the first virtual object may be created by performing the following operation: a first animation blueprint file of the first virtual object is created based on the first object skeleton; a blueprint editing interface of the first animation blueprint file is displayed in response to a file open operation for the first animation blueprint file; first editing information for an event graph in the first animation blueprint file and second editing information for an animation graph in the first animation blueprint file are received based on the blueprint editing interface; and the first animation blueprint is generated based on the first editing information and the second editing information. Herein, the process of receiving the first editing information set for the event graph and the second editing information set for the animation graph based on the blueprint editing interface is described below, and may be implemented through a related implementation related to S7 below. The event graph is configured for setting a use object of the first animation blueprint, that is, a mounting animation blueprint. The animation graph is configured for setting animation playback logic of the first animation file to place the first animation file (including the foregoing first standby animation file and the foregoing motion animation file), to control playback of the first standby animation file or the motion animation file. In this way, by setting the event graph and the animation graph, it is ensured that when the mounting animation blueprint is run to play the mounting animation, the first animation blueprint can be invoked to play an animation of the first virtual object included in the first animation file, whereby playback of the animation of the first virtual object in the mounting animation is achieved.

In some embodiments, the second animation blueprint of the second virtual object may be created by performing the following operations: a second animation blueprint file of the second virtual object is created based on the second object skeleton; a blueprint editing interface of the second animation blueprint file is played in response to a file open operation for the second animation blueprint file; third editing information for an event graph in the second animation blueprint file and fourth editing information for an animation graph in the second animation blueprint file are received based on the blueprint editing interface; and the second animation blueprint is generated based on the third editing information and the fourth editing information. Herein, the process of receiving the third editing information for the event graph and the fourth editing information for the animation graph based on the blueprint editing interface is described below, and may be implemented through a related implementation related to S6 below. The event graph is configured for setting a use object of the second animation blueprint, that is, the mounting animation blueprint. The animation graph is configured for setting animation playback logic of the second animation file to place the second animation file (including the foregoing second standby animation file), to control playback of the second standby animation file. In this way, by setting the event graph and the animation graph, it is ensured that when the mounting animation blueprint is run to play the mounting animation, the second animation blueprint can be invoked to play an animation of the second virtual object included in the second animation file, whereby playback of the animation of the second virtual object in the mounting animation is achieved.

In some embodiments, based on the bone socket, the second bone may be controlled to move along with the first bone by performing the following operations: rotation information and offset information of the bone socket during movement of the first bone are obtained; a bone rotation angle of the second bone is determined based on the rotation information and the offset information; and a bone location and a bone direction of the second bone are adjusted based on the bone rotation angle, to control the second bone to move along with the first bone.

Herein, first, the rotation information and the offset information of the bone socket during movement of the first bone are obtained. Specifically, it can be learned from the foregoing embodiments that the first virtual object is located in the first animation blueprint, and the first animation blueprint records the rotation information and the offset information of the bone socket of the first virtual object, and transfers the rotation information and the offset information of the bone socket to the second animation blueprint in which the second virtual object is located for storage. Then, the bone rotation angle of the second bone during movement of the first bone is determined based on the rotation information and the offset information, and the bone location and the bone direction of the second bone are adjusted in a bone transformation manner based on the bone rotation angle, to control the second bone to move along with the first bone. Specifically, an initial bone location and an initial bone direction of the second bone are determined, a bone transformation matrix corresponding to the bone rotation angle is determined, then bone transformation is performed on the initial bone location and the initial bone direction based on the bone transform matrix, to obtain a target bone location and a target bone direction of the second bone, and finally the bone location of the second bone is adjusted to the target bone location, and the bone direction of the second bone is adjusted to the target bone direction. In this way, the second bone moves along with the first bone, to enable the object part, bound to the second bone, of the second virtual object to move along with the object part, bound to the first bone, of the first virtual object. An animation effect of mounting the second virtual object onto the first virtual object to achieve synchronous movement can be enhanced, to make the animation effect of mounting the second virtual object onto the first virtual object to achieve synchronous movement more realistic.

In some embodiments, based on the bone socket, the second bone may be controlled to move along with the first bone by performing the following operations: rotation information and offset information of the bone socket during movement of the first bone are obtained; bone point locations of bone points on the second bone are determined in an inverse kinematics manner based on the rotation information and the offset information; and a bone location of the second bone is adjusted based on the locations of the bone points on the second bone, to control the second bone to move along with the first bone.

Herein, first, the rotation information and the offset information of the bone socket during movement of the first bone are obtained. Specifically, it can be learned from the foregoing embodiments that the first virtual object is located in the first animation blueprint, and the first animation blueprint records rotation information and offset information of the bone socket of the first virtual object, and transfers the rotation information and the offset information of the bone socket to the second animation blueprint in which the second virtual object is located for storage. After the rotation information and the offset information are obtained, the bone point locations of the bone points on the second bone are determined in an inverse kinematics manner based on the rotation information and the offset information. Specifically, the bone socket may be taken as one bone point, and the bone point locations of the bone points on the second bone that are associated with the bone point (namely, the bone socket) are determined by using an inverse kinematics principle (such as a Full-body IK algorithm) based on the rotation information and the offset information of the bone socket during movement of the first bone. Then, the bone location of the second bone is determined based on the bone point locations of the bone points on the second bone, and the location of the second bone is adjusted, to control the second bone to move along with the first bone. Specifically, first, initial bone point locations of the bone points on the second bone is determined, then target bone point locations of the bone points on the second bone are determined in an inverse kinematics manner based on the rotation information and the offset information, and the bone point locations of the bone points on the second bone are adjusted to the target bone point locations. In this way, the second bone moves along with the first bone, to enable the object part, bound to the second bone, of the second virtual object to move along with the object part, bound to the first bone, of the first virtual object. An animation effect of mounting the second virtual object onto the first virtual object to achieve synchronous movement can be enhanced, to make the animation effect of mounting the second virtual object onto the first virtual object to achieve synchronous movement more realistic.

In some embodiments, the second virtual object in the mounting animation is mounted on the first virtual object in a first mounting pose. Correspondingly, the following operations may be further performed: a mounting pose adjustment instruction is received, the mounting pose adjustment instruction including at least one of the following instructions: a first instruction configured for adjusting the bone socket from the first bone to a third bone of the first object skeleton, and a second instruction configured for adjusting the second bone to a fourth bone of the second object skeleton; and the second virtual object is controlled to be mounted on the first virtual object in a second mounting pose in response to the mounting pose adjustment instruction, the second mounting pose being different from the first mounting pose.

Specifically, (1) when the mounting pose adjustment instruction is the first instruction, the bone socket is adjusted from the first bone to the third bone in response to the mounting pose adjustment instruction; and the second bone is mounted onto the bone socket located in the third bone, to control the second virtual object to be mounted on the first virtual object in the second mounting pose. (2) When the mounting pose adjustment instruction is the second instruction, the fourth bone is mounted onto the bone socket in response to the mounting pose adjustment instruction, to control the second virtual object to be mounted on the first virtual object in the second mounting pose. (3) When the mounting pose adjustment instruction includes the first instruction and the second instruction, the bone socket is adjusted from the first bone to the third bone in response to the mounting pose adjustment instruction; and the fourth bone is mounted onto the bone socket located in the third bone, to control the second virtual object to be mounted on the first virtual object in the second mounting pose. In this way, the mounting pose can be self-defined and adjusted according to a requirement, whereby the diversity of the mounting poses is increased. In addition, the mounting poses can be adjusted only by adjusting a location of the bone socket in the first virtual object and/or only by adjusting a mounting location of the second virtual object on the bone socket, which is easy to implement and enhances the production efficiency of the mounting animation.

By applying the foregoing embodiments of this application, first, the first animation file of the first virtual object and the second animation file of the second virtual object are obtained. Then, the first object skeleton of the first virtual object is extracted from the first animation file, and the second object skeleton of the second virtual object is extracted from the second animation file. The bone socket is added to the first bone of the first object skeleton, and the second bone of the second object skeleton is mounted onto the bone socket. In this way, when the mounting animation configured for presenting that the second virtual object is mounted on the first virtual object is played, the second bone is controlled to move along with the first bone based on the bone socket, to enable the object part, bound to the second bone, of the second virtual object to move along with the object part, bound to the first bone, of the first virtual object.

Herein, (1) the second bone of the second virtual object can move along with the first bone of the first virtual object based on the bone socket, to enable the object part, bound to the second bone, of the second virtual object to move along with the object part, bound to the first bone, of the first virtual object. In this way, an animation effect of mounting the second virtual object onto the first virtual object to achieve synchronous movement can be enhanced, to make the animation effect of mounting the second virtual object onto the first virtual object to achieve synchronous movement more realistic. (2) Because the second virtual object is mounted on the first virtual object and moves along with the first virtual object through the added bone socket, mounting in different poses can be achieved through the bone socket only by adjusting an addition location (the first bone) or a mounting location (the second bone) of the bone socket, whereby the diversity of the mounting poses is increased. In addition, animation assets and animation logic of different mounting poses do not need to be respectively created for each virtual object, whereby animation production cost is reduced, and the animation production efficiency is enhanced.

The following describes an exemplary application of the embodiments of this application in an actual application scenario. In the related art, (1) different animation assets and animation logic are separately created for a carrier object and a mounted object, which allows for implementing a plurality of different mounting poses, but leads to extremely high production cost; or (2) only one set of animation assets and animation logic are created for a carrier object and a mounted object, which results in a highly unified mounting pose and leads to a poor animation effect.

Based on this, the embodiments of this application provide an animation processing method to at least solve the foregoing existing problems. In the embodiments of this application, a set of general logic for achieving synchronous movement of a second virtual object (namely, a mounted object) and a first virtual object (namely, a carrier object) is provided. Specifically, a mounting relationship is formed between the first virtual object and the second virtual object through hierarchical constraints. The mounted object is mounted on the carrier object in a proper pose (which can support customization) by using only one animation asset in combination with Full-Body IK and a socket added to a bone of the first virtual object. Furthermore, the linkage between parts, such as the limbs and the head, of the second virtual object and the body part of the first virtual object can be achieved. Debugging cost of a single first virtual object is very low, and only the location of the socket needs to be debugged. In this way, 1) only one animation asset needs to be created for the second virtual object, resulting in extremely low production cost; 2) parameters, such as a moving speed and a turning speed, of each first virtual object can be separately debugged, to enable each first virtual object to have an independent movement characteristic; 3) when applied to a virtual scene (such as a game), the animation processing method has extremely deep expansibility, and brings more possible designs for achieving a synchronous movement effect of the second virtual object and the first virtual object (for example, the second virtual object rides the first virtual object, or the second virtual object lays prone on the first virtual object); 4) if one extra first virtual object needs to be added for mounting, only the location and movement parameters of the socket need to be debugged, whereby production cost is reduced; 5) Full-Body IK is employed to enable parts, such as the limbs and the head, of the second virtual object to interact with the first virtual object, making a mounting animation effect more realistic; and 6) personalized customization of the mounting pose can be achieved only by debugging the location of the socket. Detailed descriptions are provided below.

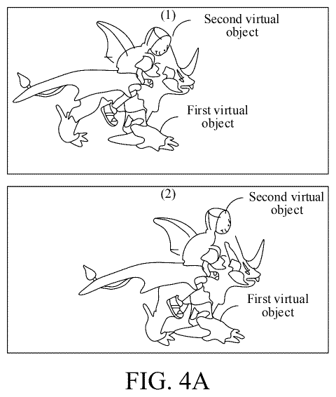

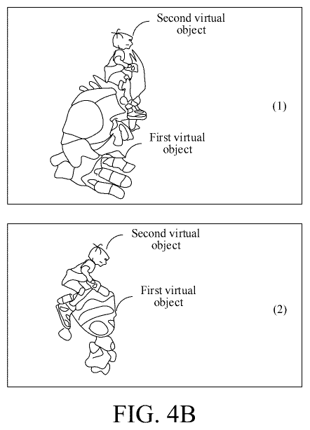

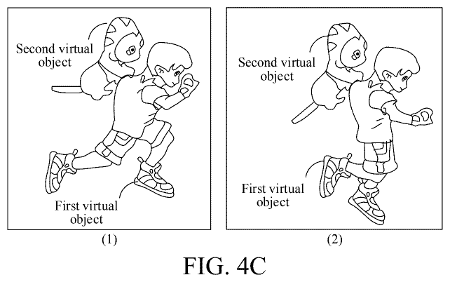

The following describes the embodiments of this application from the perspective of a product. A second bone of a second virtual object is mounted on a first bone of a first virtual object through a socket. Which bone of the second virtual object follows which bone of the first virtual object can be self-defined. However, an actual action effect brought by bone following may be very vivid. As shown in (1) and (2) in FIG. 4A, during movement of a second virtual object (such as a virtual object of a player) riding a first virtual object (such as a virtual sprite in a game), the first virtual object moves, and the second virtual object also achieves a corresponding bone movement effect. The embodiments of this application further have the advantage of generality. The second virtual object can be perfectly adapted to riding of the first virtual object of any body shape in a plurality of action poses. As shown in (1) and (2) in FIG. 4B, for different first virtual objects, riding poses of the second virtual object are different. In addition to being applied to the scenario where the second virtual object rides the first virtual object, the embodiments of this application may be applied to a scenario where the second virtual object (such as a virtual sprite) lays prone on the first virtual object (such as a virtual object of a player), namely, “accompanying behavior.” As shown in (1) and (2) in FIG. 4C, when the first virtual object moves, the second virtual object lying prone on the body of the first virtual object also moves (for example, the tail of the second virtual object moves up and down).

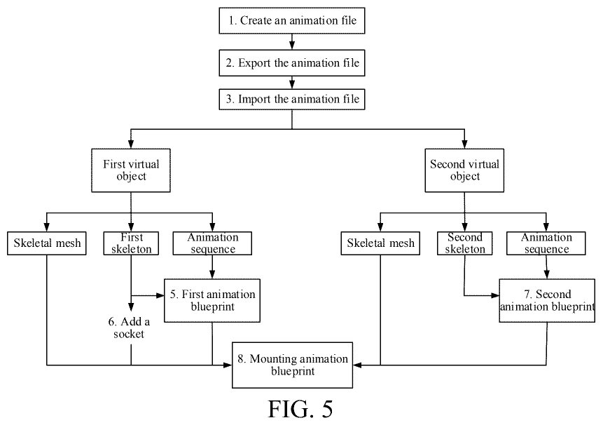

The following describes the embodiments of this application from the perspective of the technology. The process of the embodiments of this application is shown in FIG. 5:
1. Create animation files. Herein, a first animation file of a first virtual object and a second animation file of a second virtual object are created. A first standby animation file and a motion animation file of the first virtual object are created in 3dsmax, and a second standby animation file of the second virtual object in a target pose (such as a riding pose) is created.
2. Export the animation files. The first standby animation file and the motion animation file of the first virtual object and the second standby animation file of the second virtual object are exported from 3dsmax. The first standby animation file of the first virtual object is denoted as File A, the motion animation file of the first virtual object is denoted as File B, and the second standby animation file of the second virtual object is denoted as File C.
3. Import the animation files. File A, File B, and File C are imported into UE4, and after the animation files are imported, the following seven files are obtained, which are sequentially:
a skeletal mesh file (namely, the foregoing first object model) of the first virtual object, denoted as “SKM_PET”;
a first skeleton file (namely, the foregoing first object skeleton) of the first virtual object, denoted as “SK_Pet”;
a first standby animation sequence of the first virtual object, denoted as “Pet__Anim_Idle”;
a motion animation sequence of the first virtual object, denoted as “Pet__Anim_Run”;
a skeletal mesh file (namely, the foregoing second object model) of the second virtual object, denoted as “SKM_PC1”;
a second skeleton file (that is, the second object skeleton) of the second virtual object, denoted as “SK_PC1”; and
a second standby animation sequence of the second virtual object, denoted as “PC1__Anim_Ride.”
5. Create a first animation blueprint of the first virtual object. The first animation blueprint is created based on “SK_Pet,” which is denoted as “ABP_Pet,” and is configured for playing the animations “Pet__Anim_Idle” and “Pet__Anim_Run.”
6. Add a socket (namely, the foregoing bone socket) to a bone of the first virtual object. The socket is added to “SK_Pet,” and the socket is configured for 1) setting a mounting location of the second virtual object relative to the first virtual object; and 2) constraining a target bone (such as a skeleton of a part such as the limbs or the head) of the second virtual object. Exemplarily, names of sockets configured for constraining target bones may be as follows:
a socket configured for constraining a head bone of the second virtual object is denoted as “Socket_Head”;
a socket configured for constraining a left-hand bone of the second virtual object is denoted as “Socket_Hand_L”;
a socket configured for constraining a right-hand bone of the second virtual object is denoted as “Socket_Hand_R”;
a socket configured for constraining a left-foot bone of the second virtual object is denoted as “Socket_Foot_L”;
a socket configured for constraining a right-foot bone of the second virtual object is denoted as “Socket_Foot_R”; and
a mounting socket is denoted as “Ride.”
7. Create a second animation blueprint of the second virtual object. The second animation blueprint is created based on “SK_PC1,” which is denoted as “ABP_PC1,” and is configured for playing the animation “PC1__Anim_Ride” of the second virtual object, and constraining the second virtual object through the socket of the first virtual object, to enable the second virtual object to interact with the first virtual object. Specifically, “Socket Location and Rotation Data” is obtained from the animation of the first virtual object. Then, the obtained “Socket Location and Rotation Data” is endowed to FBIK. The FBIK constrains the target bone of the second virtual object to the location of the socket of the first virtual object based on the inputted “Socket Location and Rotation Data.”
8. Create a mounting animation blueprint. A blueprint with a movement component of the second virtual object is created, and then two skeletal mesh components are added, which are respectively denoted as “Component A (corresponding to the first virtual object, namely, the foregoing first skeletal mesh)” and “Component B (corresponding to the second virtual object, namely, the foregoing second skeletal mesh).” Component A carries “SKM_Pet” and the “ABP_Pet”; and Component B carries “SKM_PC1” and “ABP_PC1.” The hierarchy of Component B is set as a child of Component A, whereby Component B becomes the child of Component A. In addition, “Component B” is constrained by the socket “Ride” in “SKM_PET” included in “Component A.”

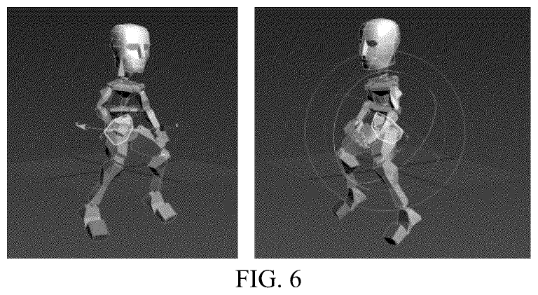

First, creation of the animation file (the second standby animation file of the second virtual object in the target pose (such as a riding pose)) is described. 1. Open 3dsMax. 2. Open the second skeleton file of the second virtual object. 3. Rotate a bone and control rotation and offset of the bone (such as a pelvis, an arm, or a thigh), to make the bone take the target pose (such as a riding pose shown in FIG. 6). 4. Export the bone in the target pose as an FBX animation file, and take the FBX animation file as the second standby animation file of the second virtual object.

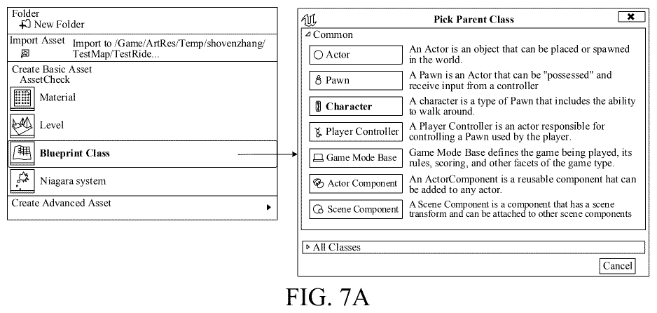

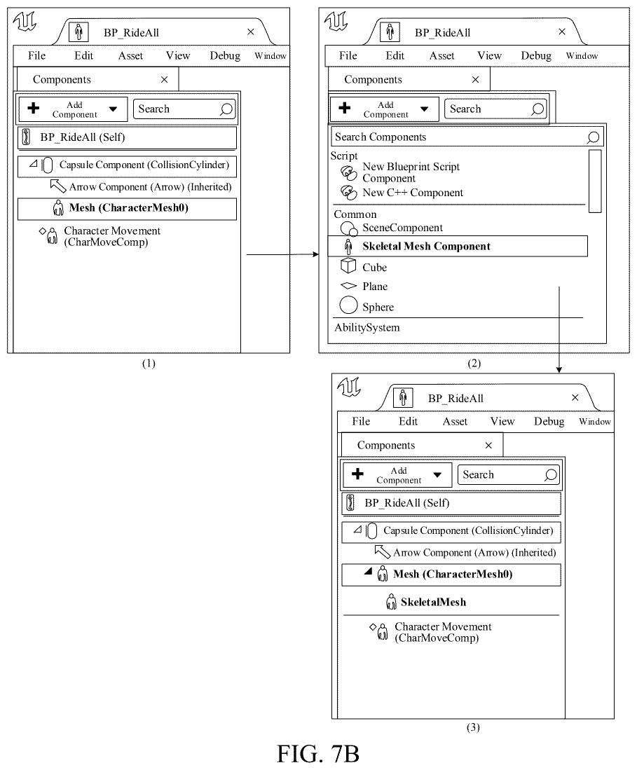

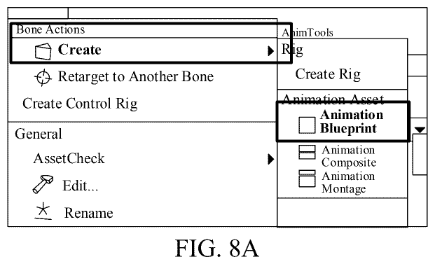

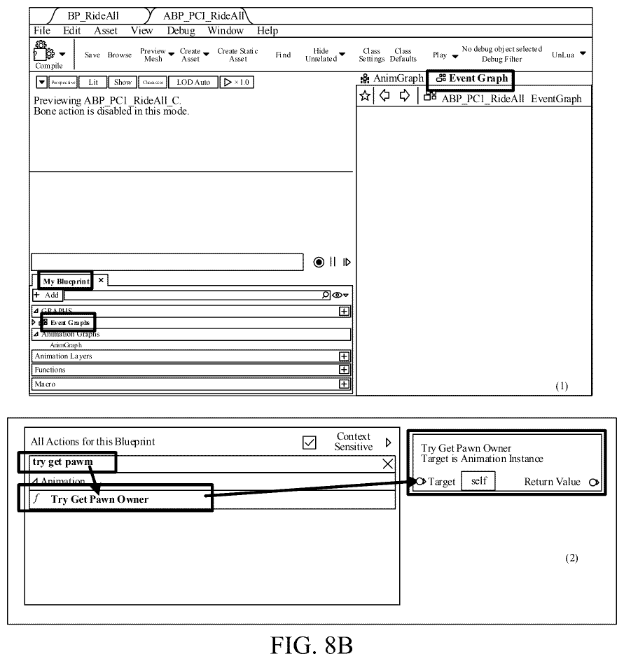

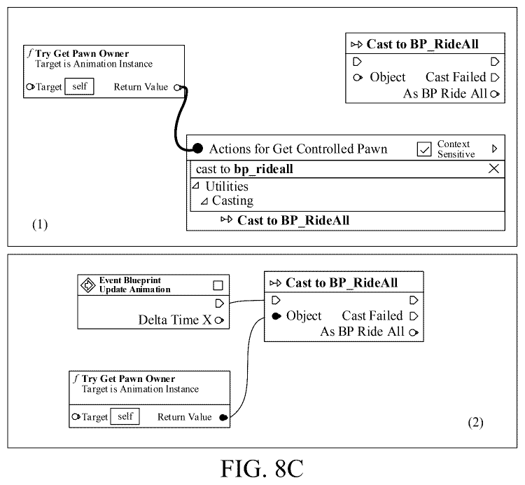

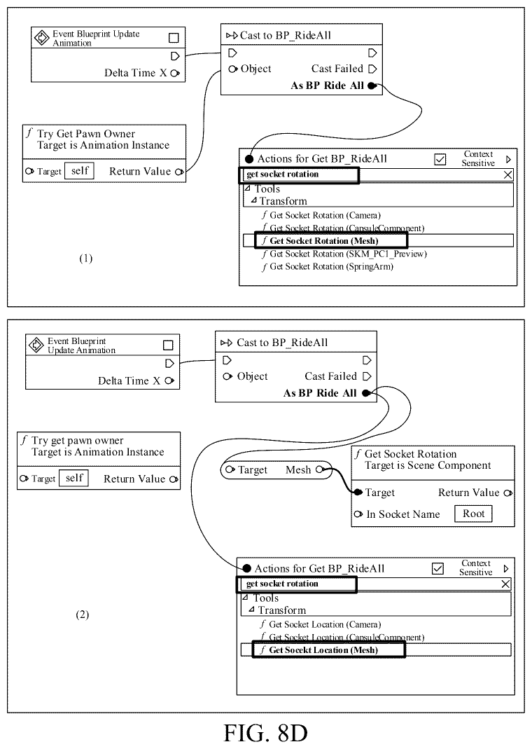

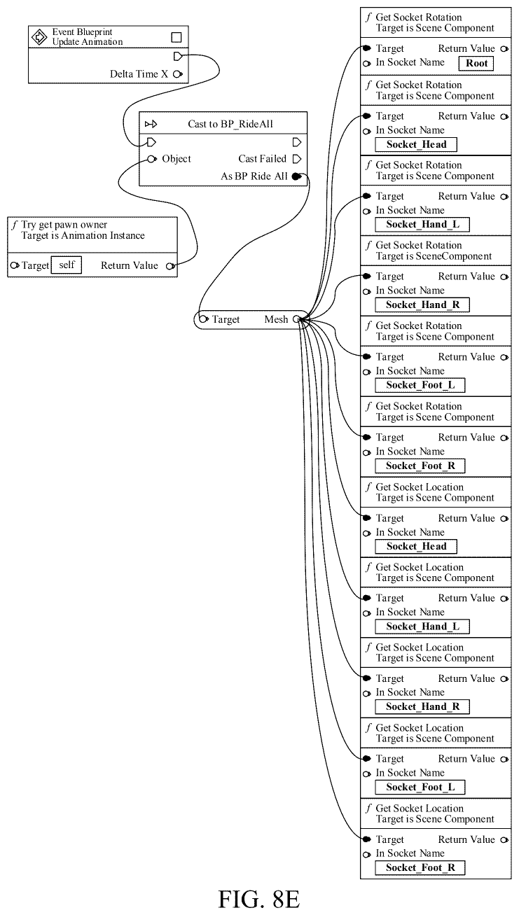

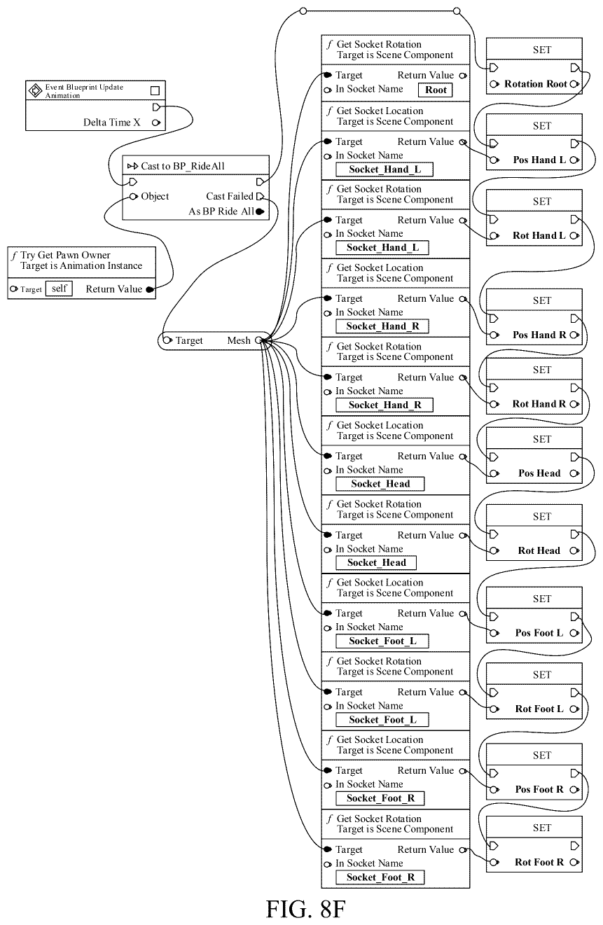

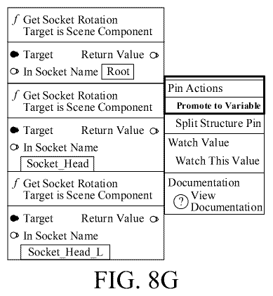

Second, logic for mounting the second virtual object onto the first virtual object through UE4 is described, which includes:
S1: Run UE4.
S2: As shown in FIG. 7A, display a shortcut menu through a click operation in a blank area of “Content Browser” of the Assets panel of the engine, and select “Blueprint Class” in the shortcut menu; and select “Character” in the new pop-up “Pick Parent Class” window. In this case, a new blueprint file is created in “Content Browser,” which is denoted as “BP_RideAll.” In this way, a mounting animation blueprint “BP_RideAll” is created, which can play the mounting animation of mounting the second virtual object onto the first virtual object.
S3: Open “BP_RideAll” in “Content Browser” through a click operation.
S4: As shown in (1) in FIG. 7B, select “Mesh (CharacterMesh0) (Inherited)” in the “Components” tab at the upper left corner of the “BP_RideAll” window. In this way, a first skeletal mesh (CharacterMesh0) is added to the mounting animation blueprint, which is configured for displaying the first virtual object. As shown in (2) in FIG. 7B, click the “Add Component” button, and select “Skeletal Mesh Component (SkeletalMesh)” in a new pop-up tab. In this way, a second skeletal mesh (SkeletalMesh) is added to the mounting animation blueprint, which is configured for displaying the second virtual object.
S5: Check whether “Skeletal Mesh Component (SkeletalMesh)” is under the hierarchy of the “Mesh (CharacterMesh0) (Inherited).” Specifically, whether there is a triangular symbol before the name of “Mesh (CharacterMesh0) (Inherited),” as shown in (3) in FIG. 7B, is checked. If there is the triangle symbol, it indicates that “Skeletal Mesh Component (SkeletalMesh)” and the “Mesh (CharacterMesh0) (Inherited)” form a hierarchical constraint, and “Skeletal Mesh Component (SkeletalMesh)” is under the hierarchy of “Mesh (CharacterMesh0) (inherited).”
S6: Create the second animation blueprint of the second virtual object, including the following process:
6.1 Import the second standby animation file of the second virtual object.
6.2 Create the second animation blueprint of the second virtual object. As shown in FIG. 8A, click the second skeleton file of the second virtual object in “Content Browser,” and select “Animation Blueprint” in “Create” in a displayed shortcut menu. In this case, a new animation blueprint is created in “Content browser,” which is denoted as “ABP_PC1_RideAll.” Herein, the second animation blueprint is configured for invoking the second standby animation file of the second virtual object.
6.3 Compile logic of an event graph in the second animation blueprint.
6.3.1 As shown in (1) in FIG. 8B, open “ABP_PC1_RideAll,” find the “My Blueprint” tab at the lower left corner of a new pop-up window, and double-click “EventGraph,” to open the “Eventgraph” tab in the middle of the window. This operation is to find and open the event graph, because logic needs to be written in the event graph next.
6.3.2 Trigger display of a text box shown in (2) in FIG. 8B through a click operation in a blank area of the event graph, input “try get pawn” into the text box, and click “Try Get Pawn Owner” in search results, to create a rightmost blueprint node “Try Get Pawn Owner” shown in (2) in FIG. 8B. This operation is to create the blueprint node “Try Get Pawn Owner,” which is configured for obtaining the user “BP_RideAll” using the second animation blueprint.
6.3.3 As shown in (1) in FIG. 8C, drag the “Return Value” pin in the blueprint node “Try Get Pawn Owner,” drop the pin in a blank area, input “BP_RideALL” into the pop-up Search box, and select “Cast to BP_RideAll” from search results, to create a blueprint node “Cast to BP_RideAll.” This operation is to create the blueprint node “Cast to BP_RideAll,” which is configured for obtaining “BP_RideAll.”
6.3.4 As shown in (2) in FIG. 8C, connect the created blueprint nodes in the second animation blueprint, and link “Event Blueprint Update Animation” to “BP_RideALL,” to obtain rotation information and offset information of the socket in real time from “BP_RideALL” during running of the engine.
6.3.5 As shown in (1) in FIG. 8D, drag the “As BP Ride All” pin in the blueprint node “Cast to BP_RideAll,” drop the pin in a blank area, input “get socket rotation” into the Search box, and select “Get Socket Rotation (Mesh)” from search results. This operation is to create the blueprint node “Get Socket Rotation,” which is configured for obtaining the rotation information of the socket from “BP_RideALL.”
6.3.6 As shown in (2) in FIG. 8D, drag the “As BP Ride All” pin in the blueprint node “Cast to BP_RideAll,” drop the pin in a blank area, input “get socket location” into the Search box, and select “Get Socket Location (Mesh)” from search results. This operation is to create the “Get Socket Location” blueprint node, which is configured for obtaining the offset information of the socket.
6.3.7 Exemplarily, create six “Get Socket Rotation” blueprint nodes and five “Get Socket Location” blueprint nodes in a replication manner.

“Root,” “Socket_Head,” “Socket_Hand_L,” “Socket_Hand_R,” “Socket_Foot_L,” and “Socket_Foot_R” are sequentially filled in the “In Socket Name” text boxes of the six “Get Socket Rotation” blueprint nodes. “Socket_Head,” “Socket_Hand_L,” “Socket_Hand_R,” “Socket_Foot_L,” and “Socket_Foot_R” are sequentially filled in the “In Socket Name” text boxes of the five “Get Socket Location” nodes.

“Socket_Head,” “Socket_Hand_L,” “Socket_Hand_R,” “Socket_Foot_L,” and “Socket_Foot_R” mentioned above are names of sockets that need to be added to the skeleton of the first virtual object, and also represent locations at which the limbs of the second virtual object interact with the body of the first virtual object. After the foregoing blueprint nodes are created, and the foregoing information is filled, a schematic diagram of blueprint nodes shown in FIG. 8E is obtained.

For each blueprint node in the eleven blueprint nodes, the “Return Value” pin is clicked, and “Promote to Variable” is selected (as shown in FIG. 8G), to create one variable. The variable is configured for storing rotation information or offset information for the blueprint node. Variables that need to be used by the eleven blueprint nodes are sequentially created, renamed based on information content, and connected based on a schematic diagram shown in FIG. 8F.

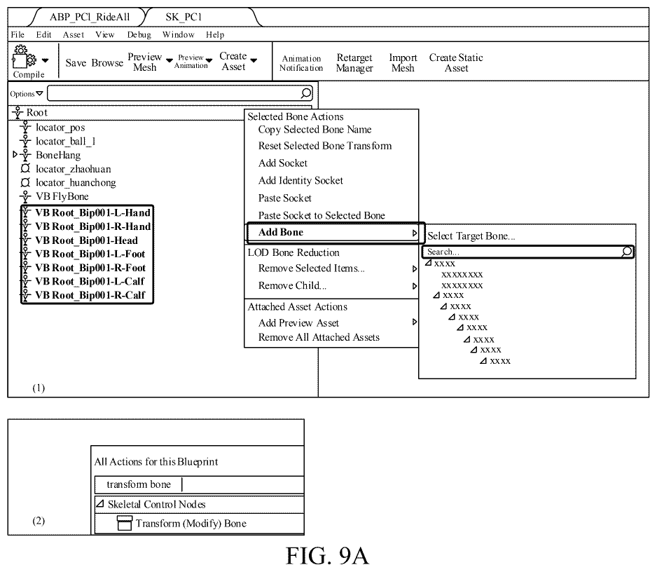

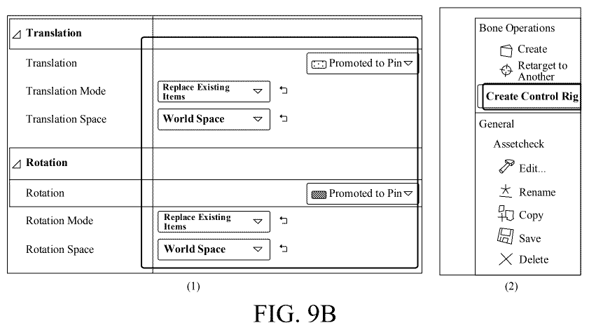

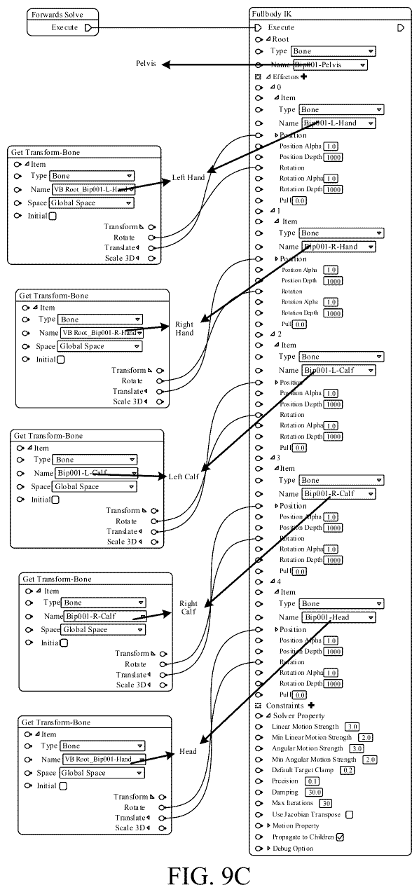

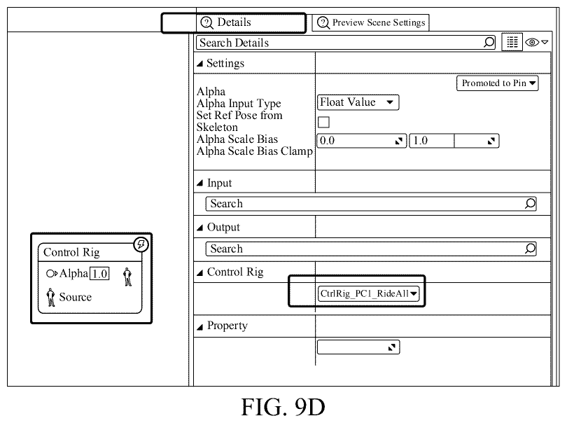

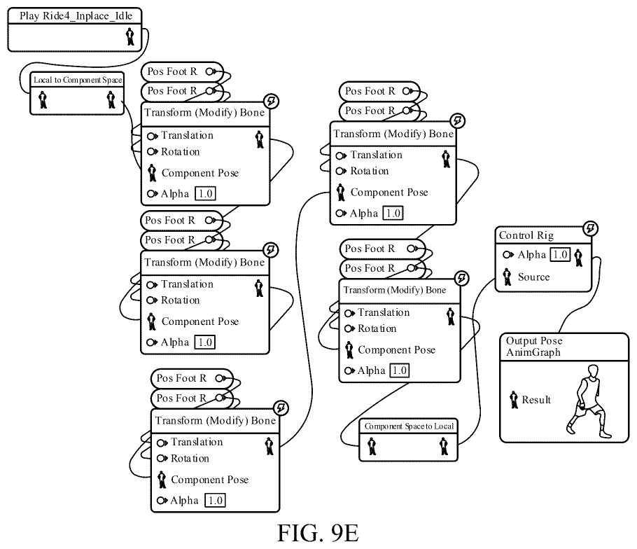

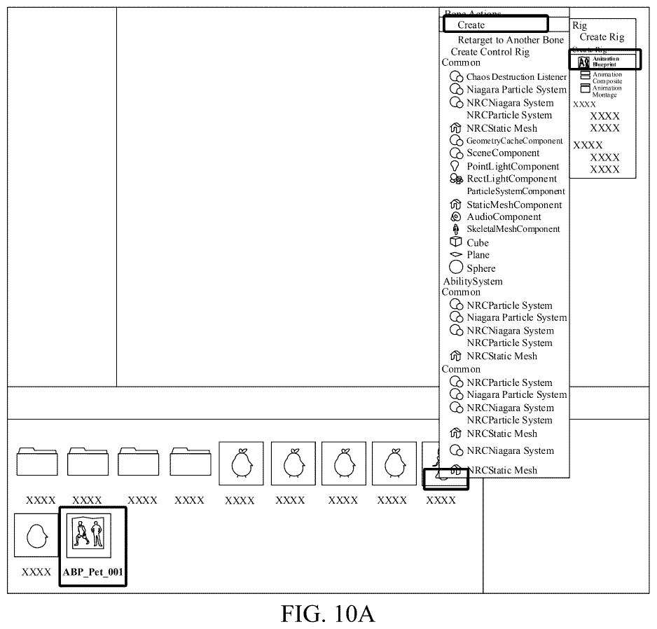

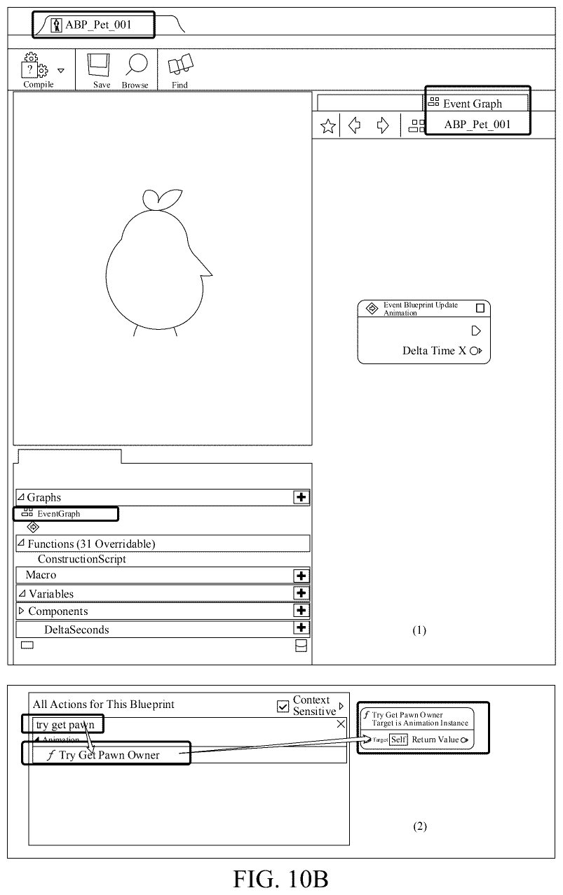

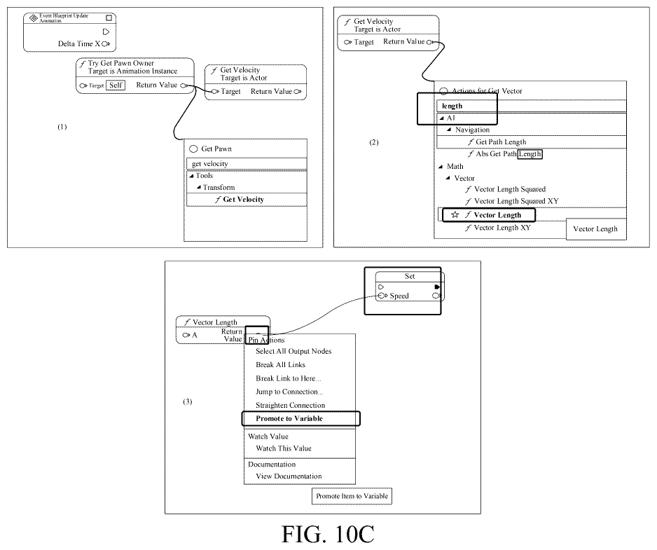

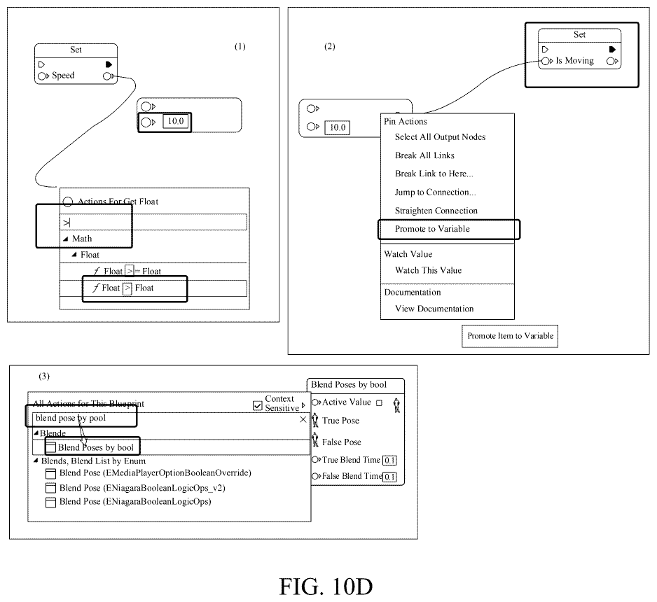

Operation 6.3.7 is to obtain the rotation information and the offset information of the socket in the skeleton of the first virtual object, and the rotation information and the offset information are stored into the variables of the second animation blueprint of the second virtual object.
6.4 Compile logic of an animation graph in the second animation blueprint.
6.4.1 As shown in (1) in FIG. 9A, open the second skeleton file of the second virtual object, click a root bone named “Root,” and select “Add Bone” in a pop-up shortcut menu. Exemplarily, “Bip001-L-Hand,” “Bip001-R-Hand,” “Bip001-Head,” “Bip001-L-Calf,” and “Bip001-R-Calf” are sequentially inputted into the Search box and added. The five bones created in this operation are subsequently used by Full-body IK to perform interaction between the second virtual object and the first virtual object.
6.4.2 As shown in (2) in FIG. 9A, return to the animation graph of the second animation blueprint, click a blank area of the animation graph, input “transform bone” in the pop-up Search box, and select “Transform (Modify) Bone” from search results. This operation is to create the “Transform (Modify) Bone” node, which is configured for modifying rotation information and offset information of the bone of the second virtual object.
6.4.3 Because a total of five bones are created in the foregoing example, five “Transform (Modify) Bone” need to be created herein. A translation mode and a rotation mode of each bone are the same: the translation mode is “Replace Existing Item,” a translation space is “World Space,” and pins are set to be public, as shown in (1) in FIG. 9B. In this operation, the public pin allows the blueprint node to use the variable for assignment. Because the location of the socket of the first virtual object needs to be assigned 100% to the bone of the mounted second virtual object, the translation mode and rotation are both “Replace Existing Item.” In 6.3.7, rotation and offset of the socket are obtained from a scene component. Therefore, correspondingly, in this operation, the rotation space and the translation space are both set to “World Space.”
6.4.4 Sequentially modify “Bone(s) to Modify” in the five “Transform (Modify) Bone” nodes into added bones; then, in the “My Blueprint” tab, drag and connect a corresponding variable to the “Transform (Modify) Bone” node; and drag the imported standby animation file of the second virtual object from “Content browser” to the animation graph. In this operation, the created single-frame animation file is taken as a basis, and then the location information and the rotation information of the bone are modified based on the animation file by connecting the blueprint nodes.
6.4.5 Click the second skeleton file of the second virtual object, and select “Create Control Rig” in a pop-up shortcut menu, to create a “Create Control Rig” file, which is denoted as “CtrlRig_PC1_RideAll,” as shown in (2) in FIG. 9B. This operation is to create the file required by usage of Full-body IK, namely, a controlrig file.
6.4.6 Open the “CtrlRig_PC1_RideAll” file, add the “Full-body Ik” node through right-click in a blank area of the “RigGraph” graph in a new pop-up window, and perform settings according to a diagram shown in FIG. 9C. This operation is to perform linkage constraint on the location of the bone and a location of a skinned bone, that is, constrain “Skinned Bone of Second Virtual Object” through “Bone of Second Virtual Object” that is already controlled by “Socket of First Virtual Object.”
6.4.7 As shown in FIG. 9D, return to the animation graph of the window of the second animation blueprint “ABP_PC1_RideAll” of the second virtual object, single-click a blank area of the graph, input “controlrig” in the pop-up Search box, and select “Control Rig” from search results. Select the “Control Rig” node, and mount the just created ControlRig file: “CtrlRig_PC1_RideAll” in the “Details” tab. This operation is to create the “Control Rig” animation blueprint node, which is configured for mounting and using the controlrig file, to constrain the limbs of the second virtual object through the socket of the first virtual object.
6.4.8 A final connection situation of the animation graph is shown in FIG. 9E.
S7: Create the first animation blueprint of the first virtual object, including the following process:
7.1 Create the first animation blueprint of the first virtual object. As shown in FIG. 10A, click the skeleton file of the first virtual object in “Content Browser,” and select “Animation Blueprint” in “Create” in a new pop-up shortcut menu. In this case, one new animation blueprint is created in “Content Browser,” which is denoted as “ABP_Pet_001.” Herein, the first animation blueprint is configured for invoking the first animation file of the first virtual object.
7.2 Compile logic of the first animation blueprint of the first virtual object.
7.2.1 As shown in (1) in FIG. 10B, open “ABP_Pet_001,” find the “My Blueprint” tab at the lower left corner of a new pop-up window, and double-click “EventGraph,” to open the “EventGraph” tab in the middle of the window. Trigger display of a text box shown in (2) in FIG. 10B through a click operation in a blank area of the event graph, input “try get pawn” into the text box, and click “Try Get Pawn Owner” in search results, to create a rightmost blueprint node “Try Get Pawn Owner” shown in (2) in FIG. 10B. This operation is to create the blueprint node, which is configured for obtaining the user “BP_RideAll” using the first animation blueprint.
7.2.2 As shown in (1) in FIG. 10C, drag the “Return Value” pin in the “Try Get Pawn Owner” node, drop the pin in a blank area, input “get velocity” into the pop-up Search box, and select “Get Velocity” from search results, to create a blueprint node “Get Velocity.”

As shown in (2) in FIG. 10C, drag the “Return Value” pin in the “Get Velocity” node, drop the pin in a blank area, input “length” into the pop-up Search box, and select “Vector Length” from search results, to create a blueprint node “Vector Length.”

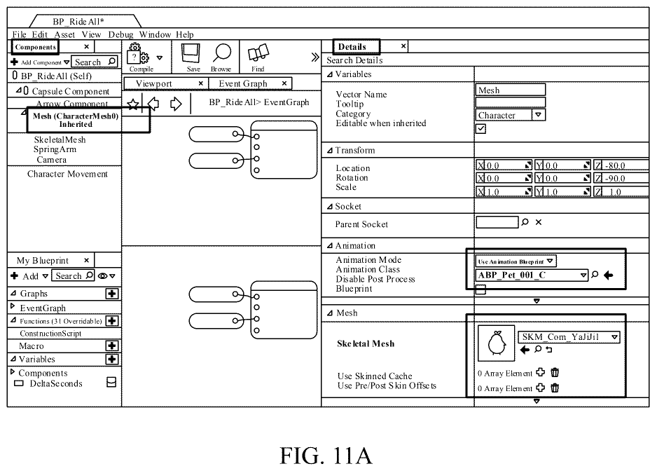

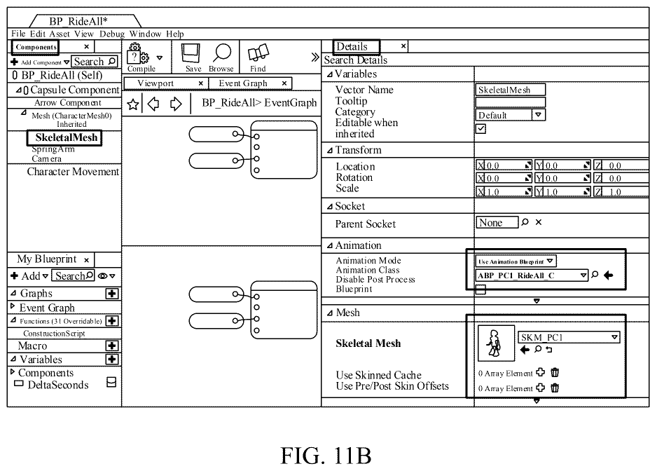

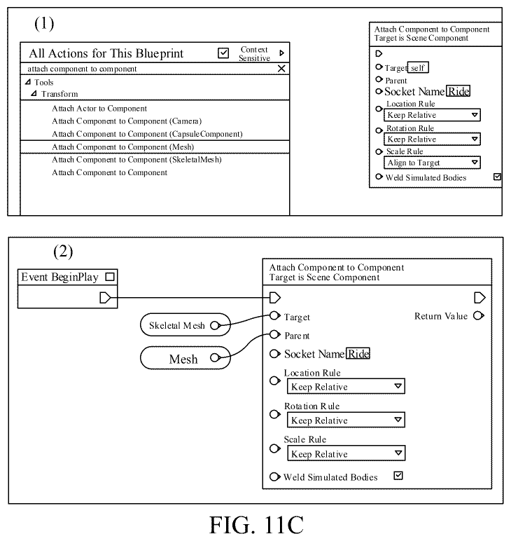

As shown in (3) in FIG. 10C, click the “Return Value” pin in the “Vector Length” node, select “Promote to Variable” in a pop-up shortcut menu, and rename a newly created variable to “Speed.” This operation is to create the “Speed” variable, which is configured for obtaining a moving speed of the first virtual object.
7.2.3 As shown in (1) in FIG. 10D, drag the “Return Value” pin in the “Speed” variable node, drop the pin in a blank area, input “>” in the pop-up Search box, select “Float>Float” from search results, and input “particular value (such as 10)” in the second text box in the newly created “Float>Float” node. This operation is to compare the moving speed, namely, the “Speed” variable, of the first virtual object with the particular value (such as 10), to determine whether a current speed is greater than 10 cm/s.
7.2.4 As shown in (2) in FIG. 10D, click a pin in the “Float>Float” node, select “Promote to Variable” in a pop-up shortcut menu, and rename a newly created variable to “isMoving.” This operation is to create the “isMoving” variable, which is configured for detecting whether the first virtual object is in a moving state. For example, if the speed is greater than 10 cm/s, the first virtual object is in the moving state, and a value of the Boolean variable is True; or if the speed is not greater than 10 cm/s, the first virtual object is not in the moving state, and a value of the Boolean variable is False.
7.2.5 As shown in (3) in FIG. 10D, double-click “AnimGraph” in the “My Blueprint” tab on the left side of a current window, to open an animation graph. Single-click a right mouse button in a blank area of the animation graph, input “blend poses by bool” into the pop-up Search box, and select “Blend Poses by bool” from search results. This operation is to create the “Blend Poses by bool” node, and the node is configured for selecting the standby animation or the motion animation for playback according to the moving state of the first virtual object.
7.2.6 In the “Asset Browser” tab, drag the standby animation file and the motion animation file to the animation graph, and connect the animations to the “Blend Poses by bool” node, the motion animation file being connected to the True pin, and the standby animation file being connected to the False pin. In the “My Blueprint” tab, drag the isMoving variable, drop the variable to the “Active Value” pin of the “Blend Poses by bool” node, and then connect the Output pin of the “Blend Poses by bool” node to the “Output Pose” node. This operation is to connect the animation files of the first virtual object to the “Blend Poses by bool” node. If a value of the isMoving variable is True, the motion animation file is played; or if a value of the variable is not True, the standby animation file is played.
S8: Compile logic of the mounting animation blueprint “BP_RideAll.”
8.1 Open “BP_RideAll.”
8.2 Select “Mesh (CharacterMesh0) Inherited” in the “Components” tab at the upper left corner, select “Skeletal Mesh” corresponding to the first virtual object from skeletal meshes in the Details panel, and select the created first animation blueprint “ABP_Pet_001” from the animation class, as shown in FIG. 11A. This operation is to place the first object model and the first animation blueprint of the first virtual object in the skeletal mesh. This operation may enable the first virtual object to “run.”
8.3 Select “SkeletalMesh” in the “Components” tab at the upper left corner, select “Skeletal Mesh” of the second virtual object from skeletal meshes in the Details panel, and select the created second animation blueprint “ABP_PC1_RideAll” from the animation class, as shown in FIG. 11B. This operation is to place the second object model and the second animation blueprint of the second virtual object in the skeletal mesh.
8.4 Trigger display of the Search box shown in (1) in FIG. 11C through a click operation in a blank area of an event graph, input “attach component to component” in the pop-up Search box, and select “Attach Component to Component (Mesh)” from search results. In this operation, the blueprint node is created, to mount the skeletal mesh “SkeletalMesh” used by the second virtual object onto a socket on the skeletal mesh “Mesh (CharacterMesh0) Inherited” used by the first virtual object.
8.5 Drag the “Mesh (CharacterMesh0) Inherited” component in the “Components” tab at the upper left corner, drop the component to the “Parent” pin of the “Attach Component to Component” node, drag the “SkeletalMesh” component in the “Components” tab, drop the component to the “Target” pin of the “Attach Component to Component” node, input “Ride” in the “Socket Name” text box, and connect a running node of the “Event Beginplay” event to the “Attach Component to Component” node. This operation is to mount the skeletal mesh component “SkeletalMesh” of the second virtual object onto the “Ride” socket of the skeletal mesh component “Mesh (CharacterMesh0) Inherited” of the first virtual object when the mounting animation blueprint starts to run. A specific connection diagram is shown in (2) in FIG. 11C.
S9: Add the socket to the skeleton of the first virtual object.
9.1 Open the first skeleton file of the first virtual object.
9.2 Open the motion animation of the first virtual object for observation. An example in which the second virtual object rides the first virtual object is taken, and it can be found that for most skeletons, the entire skeleton can basically be driven by the pelvis. Because the first virtual object drives the second virtual object, the “Ride” socket may be added to a pelvis bone of the first virtual object. An operating process is as follows: Click “Bip001” (pelvis bone), select “Add Socket” in a pop-up shortcut menu, and rename the socket to “Ride.” This operation is to create the “Ride” socket, and in this case, the skeletal mesh component of the second virtual object is mounted on the “Ride” socket, to move along with the pelvis bone of the first virtual object.
9.3 Continue to observe the motion animation of the first virtual object, and add a socket, such as “Socket_Head,” “Socket_Hand_L,” “Socket_Hand_R,” “Socket_Foot_L,” or “Socket_Foot_R,” to a proper bone. This operation is to add the socket to a proper bone of the first virtual object. Exemplarily, if locations of these sockets correspond to motions of the limbs and the head of the second virtual object, these sockets move along with a bone of the first virtual object. Therefore, the limbs and the head of the second virtual object also move along with these bones of the first virtual object.

The animation processing method is not limited to 3dsmax and UE4, and is also applicable to another DCC software or engine that can produce animations and implement mounting interaction logic. Full-Body IK is a set of IK algorithms, and the animation processing method is also applicable to cases that the mounting interaction can be achieved by the IK algorithms.

By applying the foregoing embodiments of this application, 1) only one animation asset needs to be created for the second virtual object, resulting in extremely low production cost; 2) parameters, such as a moving speed and a turning speed, of each first virtual object can be separately debugged, to enable each first virtual object to have an independent movement characteristic; 3) when applied to a virtual scene (such as a game), the animation processing method has extremely deep expansibility, and brings more possible designs for achieving a synchronous movement effect of the second virtual object and the first virtual object (for example, the second virtual object rides the first virtual object, or the second virtual object lays prone on the first virtual object); 4) if one extra first virtual object needs to be added for mounting, only the location and movement parameters of the socket need to be debugged, whereby production cost is reduced; 5) Full-Body IK is employed to enable parts, such as the limbs and the head, of the second virtual object to interact with the first virtual object, making a mounting animation effect more realistic; and 6) personalized customization of the mounting pose can be achieved only by debugging the location of the socket.

The following continues to describe an exemplary structure of the animation processing apparatus 555 implemented as a software module provided in this embodiments of this application. In some embodiments, as shown in FIG. 2, the software module in the animation processing apparatus 555 stored in the memory 550 may include: an obtaining module 5551, configured to obtain a first animation file of a first virtual object and a second animation file of a second virtual object; an extraction module 5552, configured to extract a first object skeleton of the first virtual object from the first animation file, and extract a second object skeleton of the second virtual object from the second animation file; an addition module 5553, configured to add a bone socket to a first bone of the first object skeleton; a mounting module 5554, configured to mount a second bone of the second object skeleton to the bone socket; and a playback module 5555, configured to control the second bone to move along with the first bone based on the bone socket when a mounting animation is played and the mounting animation is configured for presenting that the second virtual object is mounted on the first virtual object, during movement of the second bone along with the first bone, an object part, bound to the second bone, of the second virtual object moving along with an object part, bound to the first bone, of the first virtual object.

In some embodiments, the obtaining module 5551 is further configured to obtain a first standby animation file and a motion animation file of the first virtual object, and take the first standby animation file and the motion animation file as the first animation file; and obtain a second standby animation file of the second virtual object, and take the second standby animation file as the second animation file, the second virtual object in the second standby animation file being in a target pose, and the target pose being a pose adopted when the second virtual object is mounted on the first virtual object.

In some embodiments, the addition module 5553 is further configured to add a first bone socket to a first sub-bone of the first object skeleton, the first bone socket indicating a direct mounting location of the second virtual object relative to the first virtual object; add a second bone socket to a second sub-bone of the first object skeleton, the second bone socket indicating an indirect mounting location of the second virtual object relative to the first virtual object, the second bone socket being configured for constraining movement of a target bone in the second bone, the first bone including the first sub-bone and the second sub-bone, and the bone socket including the first bone socket and the second bone socket.

In some embodiments, before the second bone of the second object skeleton is mounted onto the bone socket, the mounting module 5554 is further configured to create a mounting animation blueprint of the mounting animation, create a first animation blueprint of the first virtual object, and create a second animation blueprint of the second virtual object; add a first skeletal mesh and a second skeletal mesh to the mounting animation blueprint, the first skeletal mesh and the second skeletal mesh having a hierarchical relationship, and the first skeletal mesh being a parent of the second skeletal mesh; obtain a first object model of the first virtual object, and place the first object model and the first animation blueprint in the first skeletal mesh, to obtain a third skeletal mesh including the first object skeleton; and obtain a second object model of the second virtual object, and place the second object model and the second animation blueprint in the second skeletal mesh, to obtain a fourth skeletal mesh including the second object skeleton.

In some embodiments, the mounting module 5554 is further configured to create a blueprint node in the mounting animation blueprint, the blueprint node including a socket pin, a first pin indicating a mounting object, and a second pin indicating a mounted object; and control the third skeletal mesh to be connected to the first pin, control the fourth skeletal mesh to be connected to the second pin, and control the socket pin to indicate the bone socket.

In some embodiments, the mounting module 5554 is further configured to create a first animation blueprint file of the first virtual object based on the first object skeleton; display a blueprint editing interface of the first animation blueprint file in response to a file open operation for the first animation blueprint file; receive first editing information for an event graph in the first animation blueprint file and second editing information for an animation graph in the first animation blueprint file based on the blueprint editing interface; and generate the first animation blueprint based on the first editing information and the second editing information.

In some embodiments, the mounting module 5554 is further configured to create a second animation blueprint file of the second virtual object based on the second object skeleton; display a blueprint editing interface of the second animation blueprint file in response to a file open operation for the second animation blueprint file; and receive third editing information for an event graph in the second animation blueprint file and fourth editing information for an animation graph in the second animation blueprint file based on the blueprint editing interface; and generate the second animation blueprint based on the third editing information and the fourth editing information.

In some embodiments, the playback module 5555 is further configured to obtain rotation information and offset information of the bone socket during movement the first bone; determine a bone rotation angle of the second bone based on the rotation information and the offset information; and adjust a bone location and a bone direction of the second bone based on the bone rotation angle.

In some embodiments, the playback module 5555 is further configured to obtain rotation information and offset information of the bone socket during movement of the first bone; determine bone point locations of bone points on the second bone in an inverse kinematics manner based on the rotation information and the offset information; and adjust a bone location of the second bone based on the locations of the bone points on the second bone.

In some embodiments, in the mounting animation, the second virtual object is mounted on the first virtual object in a first mounting pose; and the mounting module 5554 is further configured to receive a mounting pose adjustment instruction, the mounting pose adjustment instruction including at least one of the following instructions: a first instruction configured for adjusting the bone socket from the first bone to a third bone of the first object skeleton, and a second instruction configured for adjusting the second bone to a fourth bone of the second object skeleton; and control, in response to the mounting pose adjustment instruction, the second virtual object to be mounted on the first virtual object in a second mounting pose, the second mounting pose being different from the first mounting pose.

In some embodiments, the mounting module 5554 is further configured to: when the mounting pose adjustment instruction is the first instruction, adjust the bone socket from the first bone to the third bone in response to the mounting pose adjustment instruction; and mount the second bone onto the bone socket located in the third bone, to control the second virtual object to be mounted on the first virtual object in the second mounting pose; or when the mounting pose adjustment instruction is the second instruction, mount the fourth bone onto the bone socket in response to the mounting pose adjustment instruction, to control the second virtual object to be mounted on the first virtual object in the second mounting pose; or when the mounting pose adjustment instruction includes the first instruction and the second instruction, adjust the bone socket from the first bone to the third bone in response to the mounting pose adjustment instruction; and mount the fourth bone onto the bone socket located in the third bone, to control the second virtual object to be mounted on the first virtual object in the second mounting pose.

In some embodiments, before the bone socket is added to the first bone of the first object skeleton, the addition module 5553 is further configured to obtain a motion pose of the first virtual object; determine a mounting pose, adapted to the motion pose, of the second virtual object; and determine, based on the motion pose and the mounting pose, the first bone to be added with the bone socket from the first object skeleton and the second bone to be mounted onto the bone socket from the second object skeleton.

Descriptions of the apparatus embodiments in this application are similar to the descriptions of the foregoing method embodiments, and the apparatus embodiments have beneficial effects similar to those of the method embodiments. Details are not described again here. Technical details not mentioned in the animation processing apparatus provided in the embodiments of this application may be understood according to the descriptions of the technical details in the foregoing method embodiments.

The embodiments of this application further provide a computer program product. The computer program product includes computer-executable instructions or a computer program The computer-executable instructions or the computer program is stored in a computer-readable storage medium. A processor of an electronic device reads the computer-executable instructions or the computer program from the computer-readable storage medium, and executes the computer-executable instructions or the computer program, to cause the electronic device to perform the animation processing method provided in the embodiments of this application.

The embodiments of this application further provide a computer-readable storage medium. The computer-readable storage medium has computer-executable instructions or a computer program stored therein. The computer-executable instructions or the computer program, when executed by a processor, causes the processor to perform the animation processing method provided in the embodiments of this application.

In some embodiments, the computer-readable storage medium may be a memory such as a random-access memory (RAM), a read-only memory (ROM), a flash memory, a magnetic surface memory, an optical disc, or a compact disc read-only memory (CD-ROM); or may be any device including one or any combination of the foregoing memories.

In some embodiments, the computer-executable instructions may be in the form of a program, software, software module, script, or code, written in any form of programming language (including compiled or interpreted languages, or declarative or procedural languages), and may be deployed in any form, including as a stand-alone program or as a module, component, sub-routine, or another unit suitable for use in a computing environment.

As an example, the computer-executable instructions may, but do not necessarily correspond to a file in a file system, and may be stored as a part of a file that saves another program or data, for example, stored in one or more scripts in a HyperText Markup Language (HTML) file, stored in a single file dedicated to a program in discussion, or stored in a plurality of collaborative files (such as files that store one or more modules, sub-programs, or code parts).

As an example, the computer-executable instructions may be deployed to be executed on one electronic device, or executed on a plurality of electronic devices located at one location, or executed on a plurality of electronic devices that are distributed in a plurality of locations and interconnected via a communication network.

The foregoing descriptions are merely embodiments of this application, and are not intended to limit the scope of this application. Any modification, equivalent substitution, improvement, and the like made within the spirit and scope of this application fall within the scope of this application.

What is claimed is:

1. An animation processing method, performed by an electronic device, comprising:
obtaining a first animation file of a first virtual object and a second animation file of a second virtual object;
extracting a first object skeleton of the first virtual object from the first animation file, and extracting a second object skeleton of the second virtual object from the second animation file;
adding a bone socket to a first bone of the first object skeleton;
mounting a second bone of the second object skeleton onto the bone socket; and
controlling the second bone to move along with the first bone based on the bone socket in response to playing of a mounting animation that presents the second virtual object being mounted on the first virtual object, during movement of the second bone along with the first bone, an object part, bound to the second bone, of the second virtual object moving along with an object part, bound to the first bone, of the first virtual object.

2. The method according to claim 1, wherein obtaining the first animation file and the second animation file includes:
obtaining a first standby animation file and a motion animation file of the first virtual object as the first animation file; and
obtaining a second standby animation file of the second virtual object as the second animation file, the second virtual object in the second standby animation file being in a pose adopted when the second virtual object is mounted on the first virtual object.

3. The method according to claim 1, wherein:
adding the bone socket to the first bone includes:
adding a first bone socket to a first sub-bone of the first object skeleton, the first bone socket indicating a direct mounting location of the second virtual object relative to the first virtual object; and
adding a second bone socket to a second sub-bone of the first object skeleton, the second bone socket indicating an indirect mounting location of the second virtual object relative to the first virtual object, and the second bone socket being configured to constrain movement of a target bone in the second bone; and
the first bone includes the first sub-bone and the second sub-bone, and the bone socket includes the first bone socket and the second bone socket.

4. The method according to claim 1, wherein mounting the second bone includes:
creating a mounting animation blueprint of the mounting animation, creating a first animation blueprint of the first virtual object, and creating a second animation blueprint of the second virtual object;
adding a first skeletal mesh and a second skeletal mesh to the mounting animation blueprint, the first skeletal mesh being a parent of the second skeletal mesh;
obtaining a first object model of the first virtual object, and placing the first object model and the first animation blueprint in the first skeletal mesh, to obtain a third skeletal mesh including the first object skeleton; and
obtaining a second object model of the second virtual object, and placing the second object model and the second animation blueprint in the second skeletal mesh, to obtain a fourth skeletal mesh including the second object skeleton.

5. The method according to claim 4, wherein mounting the second bone further includes:
creating a blueprint node in the mounting animation blueprint, the blueprint node comprising a socket pin, a first pin indicating a mounting object, and a second pin indicating a mounted object; and
controlling the third skeletal mesh to be connected to the first pin, controlling the fourth skeletal mesh to be connected to the second pin, and controlling the socket pin to indicate the bone socket.

6. The method according to claim 4, wherein creating the first animation blueprint includes:
creating an animation blueprint file of the first virtual object based on the first object skeleton;
displaying a blueprint editing interface of the animation blueprint file in response to a file open operation for the animation blueprint file;
receiving first editing information for an event graph in the animation blueprint file and second editing information for an animation graph in the animation blueprint file based on the blueprint editing interface; and
generating the first animation blueprint based on the first editing information and the second editing information.

7. The method according to claim 4, wherein creating the second animation blueprint includes:
creating an animation blueprint file of the second virtual object based on the second object skeleton;
displaying a blueprint editing interface of the animation blueprint file in response to a file open operation for the animation blueprint file;
receiving first editing information for an event graph in the animation blueprint file and second editing information for an animation graph in the animation blueprint file based on the blueprint editing interface; and
generating the second animation blueprint based on the first editing information and the second editing information.

8. The method according to claim 1, wherein controlling the second bone to move along with the first bone includes:
obtaining rotation information and offset information of the bone socket during movement the first bone;
determining a bone rotation angle of the second bone based on the rotation information and the offset information; and
adjusting a bone location and a bone direction of the second bone based on the bone rotation angle.

9. The method according to claim 1, wherein controlling the second bone to move along with the first bone includes:
obtaining rotation information and offset information of the bone socket during movement the first bone;
determining one or more bone point locations of one or more bone points on the second bone using inverse kinematics based on the rotation information and the offset information; and
adjusting a bone location of the second bone based on the one or more bone point locations.

10. The method according to claim 1,
wherein in the mounting animation, the second virtual object is mounted on the first virtual object in a first mounting pose;
the method further comprising:
receiving a mounting pose adjustment instruction including at least one of a first instruction configured for adjusting the bone socket from the first bone to a third bone of the first object skeleton, or a second instruction configured for adjusting the second bone to a fourth bone of the second object skeleton; and
controlling, in response to the mounting pose adjustment instruction, the second virtual object to be mounted onto the first virtual object in a second mounting pose, the second mounting pose being different from the first mounting pose.

11. The method according to claim 10, wherein:
the mounting pose adjustment instruction includes the first instruction; and
controlling the second virtual object to be mounted onto the first virtual object in the second mounting pose includes:
adjusting the bone socket from the first bone to the third bone; and
mounting the second bone onto the bone socket located at the third bone, to control the second virtual object to be mounted onto the first virtual object in the second mounting pose.

12. The method according to claim 10, wherein:
the mounting pose adjustment instruction includes the second instruction; and
controlling the second virtual object to be mounted onto the first virtual object in the second mounting pose includes:
mounting the fourth bone onto the bone socket, to control the second virtual object to be mounted onto the first virtual object in the second mounting pose.

13. The method according to claim 10, wherein:
the mounting pose adjustment instruction includes the first instruction and the second instruction; and
controlling the second virtual object to be mounted onto the first virtual object in the second mounting pose includes:
adjusting the bone socket from the first bone to the third bone; and
mounting the fourth bone onto the bone socket located at the third bone, to control the second virtual object to be mounted onto the first virtual object in the second mounting pose.

14. The method according to claim 1, further comprising, before adding the bone socket to the first bone:
obtaining a motion pose of the first virtual object;
determining a mounting pose, adapted to the motion pose, of the second virtual object; and
determining, based on the motion pose and the mounting pose, the first bone from the first object skeleton and the second bone from the second object skeleton.

15. An electronic device comprising:
a memory storing computer-executable instructions; and
a processor configured to execute the computer-executable instructions to:
obtain a first animation file of a first virtual object and a second animation file of a second virtual object;
extract a first object skeleton of the first virtual object from the first animation file, and extract a second object skeleton of the second virtual object from the second animation file;
add a bone socket to a first bone of the first object skeleton;
mount a second bone of the second object skeleton onto the bone socket; and
control the second bone to move along with the first bone based on the bone socket in response to playing of a mounting animation that presents the second virtual object being mounted on the first virtual object, during movement of the second bone along with the first bone, an object part, bound to the second bone, of the second virtual object moving along with an object part, bound to the first bone, of the first virtual object.

16. The electronic device according to claim 15, wherein the processor is further configured to execute the computer-executable instructions to, when obtaining the first animation file and the second animation file:
obtain a first standby animation file and a motion animation file of the first virtual object as the first animation file; and
obtain a second standby animation file of the second virtual object as the second animation file, the second virtual object in the second standby animation file being in a pose adopted when the second virtual object is mounted on the first virtual object.

17. The electronic device according to claim 15, wherein:
the processor is further configured to execute the computer-executable instructions to, when adding the bone socket to the first bone:
add a first bone socket to a first sub-bone of the first object skeleton, the first bone socket indicating a direct mounting location of the second virtual object relative to the first virtual object; and
add a second bone socket to a second sub-bone of the first object skeleton, the second bone socket indicating an indirect mounting location of the second virtual object relative to the first virtual object, and the second bone socket being configured to constrain movement of a target bone in the second bone; and
the first bone includes the first sub-bone and the second sub-bone, and the bone socket includes the first bone socket and the second bone socket.

18. The electronic device according to claim 15, wherein the processor is further configured to execute the computer-executable instructions to, when mounting the second bone:
create a mounting animation blueprint of the mounting animation, create a first animation blueprint of the first virtual object, and create a second animation blueprint of the second virtual object;
add a first skeletal mesh and a second skeletal mesh to the mounting animation blueprint, the first skeletal mesh being a parent of the second skeletal mesh;
obtain a first object model of the first virtual object, and place the first object model and the first animation blueprint in the first skeletal mesh, to obtain a third skeletal mesh including the first object skeleton; and
obtain a second object model of the second virtual object, and place the second object model and the second animation blueprint in the second skeletal mesh, to obtain a fourth skeletal mesh including the second object skeleton.

19. The electronic device according to claim 18, wherein the processor is further configured to execute the computer-executable instructions to, when mounting the second bone:
create a blueprint node in the mounting animation blueprint, the blueprint node comprising a socket pin, a first pin indicating a mounting object, and a second pin indicating a mounted object; and
control the third skeletal mesh to be connected to the first pin, control the fourth skeletal mesh to be connected to the second pin, and control the socket pin to indicate the bone socket.

20. A non-transitory computer-readable storage medium storing computer-executable instructions or a computer program that, when executed by a processor, causes an electronic device including the processor to:
obtain a first animation file of a first virtual object and a second animation file of a second virtual object;
extract a first object skeleton of the first virtual object from the first animation file, and extract a second object skeleton of the second virtual object from the second animation file;
add a bone socket to a first bone of the first object skeleton;
mount a second bone of the second object skeleton onto the bone socket; and
control the second bone to move along with the first bone based on the bone socket in response to playing of a mounting animation that presents the second virtual object being mounted on the first virtual object, during movement of the second bone along with the first bone, an object part, bound to the second bone, of the second virtual object moving along with an object part, bound to the first bone, of the first virtual object.
